(19) United States
(12) Patent Application Publication
(10) Pub. No.: US 2024/0330706 A1
(43) Pub. Date: Oct. 3, 2024

(54) METHODS AND SYSTEMS FOR IMPROVED FEDERATED LEARNING AND IMPLEMENTATIONS THEREOF

(71) Applicant: Rutgers, The State University of New Jersey, New Brunswick, NJ (US)

(72) Inventors: Dario Pompili, Hillsborough, NJ (US); Chuanneng Sun, Edison, NJ (US)

(73) Assignee: Rutgers, The State University of New Jersey, New Brunswick, NJ (US)

(21) Appl. No.: 18/613,765

(22) Filed: Mar. 22, 2024

Related U.S. Application Data
(60) Provisional application No. 63/491,970, filed on Mar. 24, 2023.

(51) Int. Cl. G06N 3/098

(52) U.S. Cl. CPC G06N 3/098

(57) ABSTRACT

This disclosure provides novel methods and systems for novel two-way knowledge distillation-based federated learning framework (referred to as Fed2KD) that can work homogeneous models, e.g., models with different configurations, user preferences, and/or different properties of user devices. In the disclosed Fed2KD, the knowledge exchange between the global and local models is achieved by distilling the information into or out from a tiny model with unified configuration using a proxy dataset generated by conditional variational autoencoder (CVAE). In another aspect, an improved federated learning framework is disclosed that implements a federated learning-based Next Generation Radio Access Networks (NG-RAN) algorithm (referred to as FedNG). The disclosed FedNG can be implemented to address the limited capacity of the fronthaul links as well as privacy concerns.

### CROSS-REFERENCE TO RELATED APPLICATIONS

This application claims priority under 35 U.S.C. § 119(e) to U.S. Provisional Patent Application No. 63/491,970, filed Mar. 24, 2023. The foregoing application is incorporated by reference herein in its entirety.

### STATEMENT REGARDING FEDERALLY SPONSORED RESEARCH

This invention was made with government support under Grant No. 1937403 awarded by the National Science Foundation. The government has certain rights in the invention.

### FIELD

This invention relates generally to methods and systems for improved federated learning such as heterogeneous federated learning via two-way knowledge distillation and implementations thereof.

### BACKGROUND

Recently, federated learning (FL) has become a focus as a novel distributed machine learning approach over the past few years. For instance, based on iterative model averaging, Google presented, in 2017, a practical method for federated learning to train a deep learning model without centralizing the data at the data center. FL has been shown as an effective method to fundamentally enhance the performance of cloud-based radio access network (RAN) systems. For example, the FL method has been used in a Device-to-Device (D2D) communication and Mobile Edge Computing (MEC), in which the D2D groups transmit their training models to the MEC server to reduce traffic. Despite many research efforts, there are still many challenges for learning based on radio access network, including (i) privacy issues; most of the real-time applications (e.g., aerial search and rescue, mobile healthcare, and video caching) are developed on the gathered massive data from user devices. However, uploading these data to a central server for model training may cause critical privacy issues, and (ii) fronthaul capacity constraint issues: fronthaul capacity constraints in next-generation radio access networks (NG-RANs) represent the critical communication bottlenecks.

Therefore, there exists a need for improved federated learning frameworks that maintain privacy while relieving the burden on fronthaul in NG-RANs.

### SUMMARY

This disclosure addresses the need mentioned above in a number of aspects. In one aspect, this disclosure presents a method for heterogeneous federated learning through two-way knowledge distillation. In some embodiments, the method comprises: (a) configuring a local complex model of each user device and initializing a local unified model and a local variational autoencoder (VAE) of each user device; (b) training the local complex model and the local variational autoencoder of each user device using local data in each user device; (c) performing forward knowledge distillation to distill knowledge in the trained local complex model to the local unified model of each user device; (d) transmitting to a server device local unified models and trained local variational autoencoders from a plurality of user devices after completion of the forward knowledge distillation; (e) merging the local unified models and the local variational autoencoders at the server device; (f) transmitting from the server device to each user device a merged unified model and a merged variational autoencoder; and (g) performing backward knowledge distillation to distill knowledge in the merged unified model to the local complex model of each user device using data generated by the merged variational autoencoder to obtain an updated local complex model for each user device.

In some embodiments, steps (b) to (g) are repeated at least ten times. In some embodiments, steps (b) to (g) are repeated until a difference between prediction from the local complex model and prediction from the updated local complex model is less than 2%.

In some embodiments, the step of merging the local unified models comprises averaging the local unified models. In some embodiments, the step of merging the local variational autoencoders comprises averaging the local variational autoencoders.

In some embodiments, the local variational autoencoder (VAE) comprises a conditional variational autoencoder (CVAE). In some embodiments, the conditional variational autoencoder (CVAE) uses a cosine similarity regularization term in a loss function.

In some embodiments, a local complex model of a user device is different from a second local complex model of another user device. In some embodiments, the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the local complex model comprises one or more machine learning models. In some embodiments, the local complex model comprises a neural network, a convolutional neural network (CNN), a deep convolutional neural network (DCNN), a cascaded deep convolutional neural network, a simplified CNN, a shallow CNN, or a combination thereof.

In some embodiments, the local data of a user device is not shared with another user device or the server device. In some embodiments, the local unified model, the local variational autoencoder, the merged unified model, or the merged variational autoencoder does not contain personally identifiable information.

In some embodiments, the local data of each user device comprises location data of a user. In some embodiments, the local data comprises exposure status of a user to a contagious disease. In some embodiments, the contagious disease is COVID-19, influenza, or respiratory syncytial virus.

In some embodiments, the step of transmitting from the server device to each user device is performed through one or more intermediate layers. In some embodiments, the one or more intermediate layers comprise at least one distributed unit layer and/or at least one edge user layer. In some embodiments, the at least one distributed unit layer or the at least one edge user layer comprises one or more edge server devices deployed in proximity to the plurality of user devices.

In some embodiments, the one or more intermediate layers comprise an edge aggregation layer between the at least one distributed unit layer and the at least one edge user layer, and wherein the edge aggregation layer performs functions comprising caching frequently accessed content, processing data, and/or providing low-latency access to applications and services.

In some embodiments, the method comprises: before steps (d), transmitting to the one or more intermediate layers the local unified models and the trained local variational autoencoders from the plurality of user devices after completion of the forward knowledge distillation, wherein each of the one or more edge server devices of the one or more intermediate layers receives the local unified models and the trained local variational autoencoders of at least a subset of the plurality of user devices; merging the local unified models and the local variational autoencoders of at least the subset of the plurality of user devices at the one or more edge server devices; and transmitting from the one or more edge server devices to the server device merged unified models and merged variational autoencoders to perform further merging at step (e).

In some embodiments, step (f) comprises transmitting from the server device, through the one or more intermediate layers, to each user device a final merged unified model and a final merged variational autoencoder.

In another aspect, this disclosure provides a method for efficient heterogeneous federated learning through two-way knowledge distillation. In some embodiments, the method comprises: (a) configuring a local complex model of each user device and initializing a local unified model and a local variational autoencoder (VAE) of each user device; (b) training the local complex model and the local variational autoencoder of each user device using local data in each user device; (c) performing forward knowledge distillation to distill knowledge in the trained local complex model to the local unified model of each user device; (d) transmitting to one or more intermediate layers comprising one or more edge server devices local unified models and trained local variational autoencoders from the plurality of user devices after completion of the forward knowledge distillation, wherein each of the one or more edge server devices receives the local unified models and the trained local variational autoencoders of at least a subset of the plurality of user devices; (e) merging the local unified models and the local variational autoencoders of at least the subset of the plurality of user devices at the one or more edge server devices; (f) transmitting from the one or more edge server devices to a central unit layer comprising a server device merged unified models and merged variational autoencoders to perform further merging; (g) further merging the merged local unified models and the merged local variational autoencoders at the server device to obtain a final merged unified model and a final merged local variational autoencoder; (h) transmitting from the server device through the one or more intermediate layers to each user device the final merged unified model and the final merged variational autoencoder; and (i) performing backward knowledge distillation to distill knowledge in the final merged unified model to the local complex model of each user device using data generated by the final merged variational autoencoder to obtain an updated local complex model for each user device. In some embodiments, steps (b) to (i) are repeated at least ten times.

In yet another aspect, this disclosure also provides a method for efficient federated learning. In some embodiments, the method comprises: (i) configuring a local complex model of each user device; (ii) training the local complex model of each user device using local data in each user device; (iii) transmitting to at least one intermediate layer comprising one or more edge server devices trained local complex models of at least a subset of a plurality of user devices; (iv) merging the trained local complex models of at least a subset of the plurality of user devices at each of the one or more edge server devices; (v) transmitting to a central unit layer comprising a server device the merged local complex models from the one or more edge server devices; (vi) further merging at the central unit layer the merged local complex models from the one or more edge server devices to obtain a final merged complex model; (vii) transmitting from the central unit layer, through the at least one intermediate layer, to each user device the final merged complex model; and (viii) updating the local complex model of each user device based on the final merged complex model to obtain an updated local complex model for each user device.

In some embodiments, step (i) comprises initializing a local unified model and a local variational autoencoder (VAE) of each user device.

In some embodiments, step (ii) comprises training the local variational autoencoder (VAE) of each user device using local data in each user device.

In some embodiments, the method comprises, after step (ii) and prior to step (iii), performing forward knowledge distillation to distill knowledge in the trained local complex model to the local unified model of each user device.

In some embodiments, step (iii) comprises transmitting to the one or more edge server devices of the at least one intermediate layer local unified models and trained local variational autoencoders from a least a subset of the plurality of user devices after completion of the forward knowledge distillation.

In some embodiments, step (iv) comprises merging the local unified models and the local variational autoencoders at the one or more edge server devices of the at least one intermediate layer.

In some embodiments, step (v) comprises transmitting to the central unit layer the merged unified models and the merged local variational autoencoders from the one or more edge server devices.

In some embodiments, step (vi) comprises further merging, at the central unit layer, the merged unified models and the merged local variational autoencoders from the one or more edge server devices to obtain a final merged unified model and a final merged variational autoencoder.

In some embodiments, step (vii) comprises transmitting from the central unit layer, through the at least one intermediate layer, to each user device the final merged unified model and the final merged variational autoencoder.

In some embodiments, step (vii) comprises updating the local complex model of each user device based on the final merged unified model and data generated by the final merged variational autoencoder.

In some embodiments, the step of merging the local unified models comprises averaging the local unified models. In some embodiments, the step of merging the local variational autoencoders comprises averaging the local variational autoencoders.

In some embodiments, the local variational autoencoder (VAE) is a conditional variational autoencoder (CVAE). In some embodiments, the conditional variational autoencoder (CVAE) uses a cosine similarity regularization term in a loss function.

In some embodiments, a local complex model of a user device is different from a second local complex model of another user device. In some embodiments, the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks.

Also within the scope of this disclosure is a system for heterogeneous federated learning through two-way knowledge distillation. In some embodiments, the system comprises: a plurality of user devices and a server device, and one or more processors configured to: (a) configure a local complex model of each user device of the plurality of user devices and initialize a local unified model and a local variational autoencoder (VAE) of each user device; (b) train the local complex model and the local variational autoencoder of each user device using local data in each user device; (c) perform forward knowledge distillation to distill knowledge in the trained local complex model to the local unified model of each user device; (d) transmit to the server device local unified models and trained local variational autoencoders from the plurality of user devices after completion of the forward knowledge distillation; (e) merge the local unified models and the local variational autoencoders at the server device; (f) transmit from the server device to each user device a merged unified model and a merged variational autoencoder; and (g) perform backward knowledge distillation to distill knowledge in the merged unified model to the local complex model of each user device using data generated by the merged variational autoencoder to obtain an updated local complex model for each user device.

In some embodiments, the one or more processors are configured to repeat steps (b) to (g) at least ten times. In some embodiments, the one or more processors are configured to repeat steps (b) to (g) until a difference between prediction from the local complex model and prediction from the updated local complex model is less than 2%.

In some embodiments, the step of merging the local unified models comprises averaging the local unified models. In some embodiments, the step of merging the local variational autoencoders comprises averaging the local variational autoencoders.

In some embodiments, the local variational autoencoder (VAE) comprises a conditional variational autoencoder (CVAE).

In some embodiments, a local complex model of a user device is different from a second local complex model of another user device.

In some embodiments, the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the local complex model comprises one or more machine learning models. In some embodiments, the local complex model comprises a neural network, a convolutional neural network (CNN), a deep convolutional neural network (DCNN), a cascaded deep convolutional neural network, a simplified CNN, a shallow CNN, or a combination thereof.

In some embodiments, the local data of a user device is not shared with another user device or the server device. In some embodiments, the local unified model, the local variational autoencoder, the merged unified model, or the merged variational autoencoder does not contain personally identifiable information.

In some embodiments, the local data of each user device comprises location data of a user. In some embodiments, the local data comprises exposure status of a user to a contagious disease. In some embodiments, the contagious disease is COVID-19, influenza, or respiratory syncytial virus.

In some embodiments, the step of transmitting from the server device to each user device is performed through one or more intermediate layers.

In some embodiments, the one or more intermediate layers comprise at least one distributed unit layer and/or at least one edge user layer. In some embodiments, the at least one distributed unit layer or the at least one edge user layer comprises one or more edge server devices deployed in proximity to the plurality of user devices

In some embodiments, the one or more processors are configured to: before steps (d), transmit to the one or more intermediate layers the local unified models and the trained local variational autoencoders from the plurality of user devices after completion of the forward knowledge distillation, wherein each of the one or more edge server devices of the one or more intermediate layers receives the local unified models and the trained local variational autoencoders of at least a subset of the plurality of user devices; merge the local unified models and the local variational autoencoders of at least the subset of the plurality of user devices at the one or more edge server devices; and transmit from the one or more edge server devices to the server device merged unified models and merged variational autoencoders to perform further merging at step (e).

In some embodiments, step (f) comprises transmitting from the server device, through the one or more intermediate layers, to each user device a final merged unified model and a final merged variational autoencoder.

In another aspect, this disclosure additionally provides a system for efficient heterogeneous federated learning through two-way knowledge distillation. In some embodiments, the system comprises a plurality of user devices, one or more intermediate layers comprising one or more edge server devices, a server device, and one or more processors configured to: (a) configure a local complex model of each user device of the plurality of user devices and initialize a local unified model and a local variational autoencoder (VAE) of each user device; (b) train the local complex model and the local variational autoencoder of each user device using local data in each user device; (c) perform forward knowledge distillation to distill knowledge in the trained local complex model to the local unified model of each user device; (d) transmit to one or more intermediate layers comprising one or more edge server devices local unified models and trained local variational autoencoders from the plurality of user devices after completion of the forward knowledge distillation, wherein each of the one or more edge server devices receives the local unified models and the trained local variational autoencoders of at least a subset of the plurality of user devices; (e) merge the local unified models and the local variational autoencoders of at least the subset of the plurality of user devices at the one or more edge server devices; (f) transmit from the one or more edge server devices to a central unit layer comprising a server device merged unified models and merged variational autoencoders to perform further merging; (g) further merge the merged local unified models and the merged local variational autoencoders at the server device to obtain a final merged unified model and a final merged local variational autoencoder; (h) transmit from the server device through the one or more intermediate layers to each user device the final merged unified model and the final merged variational autoencoder; and (i) perform backward knowledge distillation to distill knowledge in the final merged unified model to the local complex model of each user device using data generated by the final merged variational autoencoder to obtain an updated local complex model for each user device.

In some embodiments, the one or more processors are configured to repeat steps (b) to (i) at least ten times.

In yet another aspect, this disclosure provides a system for efficient federated learning. In some embodiments, the system comprises: a plurality of user devices, at least one intermediate layers comprising one or more edge server devices, a central unit layer comprising a server device, and one or more processors configured to: (i) configure a local complex model of each user device of the plurality of user devices; (ii) train the local complex model of each user device using local data in each user device; (iii) transmit to the at least one intermediate layer trained local complex models of at least a subset of a plurality of user devices; (iv) merge the trained local complex models of at least a subset of the plurality of user devices at each of the one or more edge server devices; (v) transmit to the central unit layer the merged local complex models from the one or more edge server devices; (vi) further merge at the central unit layer the merged local complex models from the one or more edge server devices to obtain a final merged complex model; (vii) transmit from the central unit layer, through the at least one intermediate layer, to each user device the final merged complex model; and (viii) update the local complex model of each user device based on the final merged complex model to obtain an updated local complex model for each user device.

In some embodiments, step (i) comprises initializing a local unified model and a local variational autoencoder (VAE) of each user device.

In some embodiments, step (ii) comprises training the local variational autoencoder (VAE) of each user device using local data in each user device.

In some embodiments, the one or more processors are configured to, after step (ii) and prior to step (iii), perform forward knowledge distillation to distill knowledge in the trained local complex model to the local unified model of each user device.

In some embodiments, step (iii) comprises transmitting to the one or more edge server devices of the at least one intermediate layer local unified models and trained local variational autoencoders from a least a subset of the plurality of user devices after completion of the forward knowledge distillation.

In some embodiments, step (iv) comprises merging the local unified models and the local variational autoencoders at the one or more edge server devices of the at least one intermediate layer.

In some embodiments, step (v) comprises transmitting to the central unit layer the merged unified models and the merged local variational autoencoders from the one or more edge server devices.

In some embodiments, step (vi) comprises further merging, at the central unit layer, the merged unified models and the merged local variational autoencoders from the one or more edge server devices to obtain a final merged unified model and a final merged variational autoencoder.

In some embodiments, step (vii) comprises transmitting from the central unit layer, through the at least one intermediate layer, to each user device the final merged unified model and the final merged variational autoencoder.

In some embodiments, step (vii) comprises updating the local complex model of each user device based on the final merged unified model and data generated by the final merged variational autoencoder.

In some embodiments, the step of merging the local unified models comprises averaging the local unified models. In some embodiments, the step of merging the local variational autoencoders comprises averaging the local variational autoencoders.

In some embodiments, the local variational autoencoder (VAE) is a conditional variational autoencoder (CVAE). In some embodiments, the conditional variational autoencoder (CVAE) uses a cosine similarity regularization term in a loss function.

In some embodiments, a local complex model of a user device is different from a second local complex model of another user device. In some embodiments,
the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combinations of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 shows an example scheme of forward and backward knowledge distillation.

FIG. 2 shows an example workflow of the Fed2KD framework.

FIG. 3 shows an example process involving transferring knowledge from personalized models to a unified model, merging the unified model, and distilling the knowledge back to personalized models.

FIG. 4 shows that lightweight CVAE trained on the local data on each device, merging CVAE on the devices, and generating proxy datasets using CVAE.

FIG. 5 shows merging of unified models and CVAEs.

FIGS. 6a, 6b, 6c, and 6d show the testing accuracy of MLPs (FIG. 6a) and CNNs (FIG. 6b) trained on MNIST dataset with α=0.05 and the testing accuracy of MLPs (FIG. 6c) and CNNs (FIG. 6d) trained on MNIST dataset with α=10. The dashed vertical line at x=20 indicates the start of using CVAE.

FIGS. 7a, 7b, 7c, and 7d show the testing accuracy of MLPs (FIG. 7a) and CNNs (FIG. 7b) trained on FashionMNIST dataset with α=0.05 and the testing accuracy of MLPs (FIG. 7c) and CNNs (FIG. 7d) trained on MNIST dataset with α=10.

FIGS. 8a, 8b, 8c, and 8d show the testing accuracy of MLPs (FIG. 8a) and CNNs (FIG. 8b) trained on MNIST dataset and MLPs (FIG. 8c) and CNNs (FIG. 8d) trained on FashionMNIST dataset with different a values.

FIG. 9 shows an example interface DP4coRUna APP.

FIG. 10 shows an example NG-RAN architecture for implementing a federated learning framework.

FIG. 11 shows an example iteration in the FedNG algorithm.

FIG. 12 shows an example iteration in the FedBNG algorithm.

FIGS. 13a, 13b, and 13c show accuracy vs. number of training samples on MNIST dataset with fully connected neural networks (FIG. 13a), CIFAR10 dataset with convolutional neural networks (FIG. 13b), and IMDB sentimental analysis dataset with recurrent neural networks (FIG. 13c).

FIGS. 14a, 14b, and 14c show total traffic in the network vs. the number of UEs (FIG. 14a), the number of DUs (FIG. 14b), and varied number of UEs and DUs with the same DU/UE ratio (FIG. 14c).

FIGS. 15a, 15b, and 15c show latency against the number of UEs (FIG. 15a), latency vs. the number of DUs (FIG. 15b), and testing accuracy vs. CU aggregation interval (FIG. 15c). FIG. 15c is generated on MNIST dataset.

### DETAILED DESCRIPTION

This disclosure provides novel methods and systems for novel two-way knowledge distillation-based federated learning framework (referred to as Fed2KD) that can work homogeneous models, e.g., models with different configurations, user preferences, and/or different properties of user devices. In the disclosed Fed2KD, the knowledge exchange between the global and local models is achieved by distilling the information into or out from a tiny model with a unified configuration using a proxy dataset generated by conditional variational autoencoder (CVAE). One of the advantages of the Fed2KD is that user private data is not shared with other devices (e.g., other user devices or server devices). Compared to the existing Federated Averaging (FedAvg) framework, the disclosed Fed2KD demonstrates significant improvement at least in performance (e.g., 30% improvement on MNIST datasets and 18% on FashionMNIST datasets) using non-independent and identically distributed (non-IID) data.

In another aspect, an improved federated learning framework is disclosed that implements a federated learning-based next-generation radio access networks (NG-RAN) algorithm (referred to as FedNG). The disclosed FedNG can be implemented to address the limited capacity of the fronthaul links as well as privacy concerns. The FedNG employs user equipment (UEs) and NG-RAN infrastructures, which collaborate throughout the learning process and the sharing prediction model to ensure privacy and relieve the burden on fronthaul interface. In particular, the FedNG allows distributed units (DUs) to cooperatively learn a shared predictive model by taking the first-phase training models of the distributed units as the initial input of the local training and then uploading sub-optimal distributed unit models to the central unit (CU) to involve in the next phase of global training. As demonstrated in this disclosure, the disclosed FedNG significantly outperforms the existing state-of-the-art solutions based on Federated Averaging (FedAvg).

Importantly, the disclosed improved federated learning frameworks can be implemented alone or in combination for various applications, including pandemic risk management.

### Fed2KD: Heterogeneous Federated Learning via Two-Way Knowledge Distillation

In one aspect, this disclosure presents a method for heterogeneous federated learning through two-way knowledge distillation. In some embodiments, the method comprises: (a) configuring a local complex model of each user device and initializing a local unified model and a local variational autoencoder (VAE) of each user device; (b) training the local complex model and the local variational autoencoder of each user device using local data in each user device; (c) performing forward knowledge distillation to distill knowledge in the trained local complex model to the local unified model of each user device; (d) transmitting to a server device local unified models and trained local variational autoencoders from a plurality of user devices after completion of the forward knowledge distillation; (e) merging the local unified models and the local variational autoencoders at the server device; (f) transmitting from the server device to each user device a merged unified model and a merged variational autoencoder; and (g) performing backward knowledge distillation to distill knowledge in the merged unified model to the local complex model of each user device using data generated by the merged variational autoencoder to obtain an updated local complex model for each user device.

In some embodiments, steps (b) to (g) are repeated at least ten times. In some embodiments, steps (b) to (g) are repeated until a difference between prediction from the local complex model and prediction from the updated local complex model is less than 5% (e.g., 5%, 4%, 3%, 2%, 1%, 0.5%, 0.1%).

In some embodiments, the step of merging the local unified models comprises averaging the local unified models. In some embodiments, the step of merging the local variational autoencoders comprises averaging the local variational autoencoders.

As used herein, “federated learning” refers to a method of machine learning by uniting different participants (participants, or parties, also known as data owners or clients). In the disclosed federated learning framework, participants do not need to expose their own data to other participants and coordinators (e.g., server devices), so the disclosed federated learning framework is advantageous in protecting user privacy and ensure data security.

In some embodiments, the local variational autoencoder (VAE) comprises a conditional variational autoencoder (CVAE). In machine learning, a variational autoencoder, is an artificial neural network architecture belonging to the families of probabilistic graphical models and variational Bayesian methods. Variational autoencoders are often associated with the autoencoder model because of its architectural affinity, but with significant differences in the goal and mathematical formulation. Variational autoencoders are probabilistic generative models that require neural networks as only a part of their overall structure. The neural network components are typically referred to as the encoder and decoder for the first and second components, respectively. The first neural network maps the input variable to a latent space that corresponds to the parameters of a variational distribution. In this way, the encoder can produce multiple different samples that all come from the same distribution. The decoder has the opposite function, which is to map from the latent space to the input space, in order to produce or generate data points. Both networks are typically trained together with the usage of the reparameterization trick, although the variance of the noise model can be learned separately.

Conditional variational autoencoder (CVAE) is an extension of variational autoencoder. The conditional variational autoencoder inserts label information in the latent space to force a deterministic constrained representation of the learned data. In some embodiments, the conditional variational autoencoder (CVAE) uses a cosine similarity regularization term in a loss function.

In some embodiments, a local complex model of a user device is different from a second local complex model of another user device. In some embodiments, the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the local complex model comprises one or more machine learning models. In some embodiments, the local complex model comprises a neural network, a convolutional neural network (CNN), a deep convolutional neural network (DCNN), a cascaded deep convolutional neural network, a simplified CNN, a shallow CNN, or a combination thereof.

As used herein, the term “convolutional neural network” or “CNN” refers to a deep feed-forward artificial neural network. Optionally, a convolutional neural network includes a plurality of convolutional layers, a plurality of up-sampling layers, and a plurality of down-sampling layers. For example, a respective one of the plurality of convolutional layers can process an image. An up-sampling layer and a down-sampling layer can change a scale of an input image to one corresponding to a certain convolutional layer. The output from the up-sampling layer or the down-sampling layer can then be processed by a convolutional layer of a corresponding scale. This enables the convolutional layer to add or extract a feature having a scale different from that of the input image. By pre-training, parameters include, but are not limited to, a convolutional kernel, a bias, and a weight of a convolutional layer of a convolutional neural network that can be tuned. Accordingly, the convolutional neural network can be used in various applications such as image recognition, image feature extraction, and image feature addition.

In some embodiments, the local data of a user device is not shared with another user device or the server device. In some embodiments, the local unified model, the local variational autoencoder, the merged unified model, or the merged variational autoencoder does not contain personally identifiable information.

In some embodiments, the local data of each user device comprises location data of a user. In some embodiments, the local data comprises exposure status of a user to a contagious disease. In some embodiments, the contagious disease is COVID-19, influenza, or respiratory syncytial virus.

In some embodiments, the step of transmitting from the server device to each user device is performed through one or more intermediate layers. In some embodiments, the one or more intermediate layers comprise at least one distributed unit layer and/or at least one edge user layer. In some embodiments, the at least one distributed unit layer or the at least one edge user layer comprises one or more edge server devices deployed in proximity to the plurality of user devices.

In some embodiments, the one or more intermediate layers comprise an edge aggregation layer between the at least one distributed unit layer and the at least one edge user layer, and wherein the edge aggregation layer performs functions comprising caching frequently accessed content, processing data, and/or providing low-latency access to applications and services.

In some embodiments, the method comprises: before steps (d), transmitting to the one or more intermediate layers the local unified models and the trained local variational autoencoders from the plurality of user devices after completion of the forward knowledge distillation, wherein each of the one or more edge server devices of the one or more intermediate layers receives the local unified models and the trained local variational autoencoders of at least a subset of the plurality of user devices; merging the local unified models and the local variational autoencoders of at least the subset of the plurality of user devices at the one or more edge server devices; and transmitting from the one or more edge server devices to the server device merged unified models and merged variational autoencoders to perform further merging at step (e).

In some embodiments, step (f) comprises transmitting from the server device, through one or more intermediate layers, to each user device a final merged unified model and a final merged variational autoencoder.

In another aspect, this disclosure provides a method for efficient heterogeneous federated learning through two-way knowledge distillation. In some embodiments, the method comprises: (a) configuring a local complex model of each user device and initializing a local unified model and a local variational autoencoder (VAE) of each user device; (b) training the local complex model and the local variational autoencoder of each user device using local data in each user device; (c) performing forward knowledge distillation to distill knowledge in the trained local complex model to the local unified model of each user device; (d) transmitting to one or more intermediate layers comprising one or more edge server devices local unified models and trained local variational autoencoders from the plurality of user devices after completion of the forward knowledge distillation, wherein each of the one or more edge server devices receives the local unified models and the trained local variational autoencoders of at least a subset of the plurality of user devices; (e) merging the local unified models and the local variational autoencoders of at least the subset of the plurality of user devices at the one or more edge server devices; (f) transmitting from the one or more edge server devices to a central unit layer comprising a server device merged unified models and merged variational autoencoders to perform further merging; (g) further merging the merged local unified models and the merged local variational autoencoders at the server device to obtain a final merged unified model and a final merged local variational autoencoder; (h) transmitting from the server device through the one or more intermediate layers to each user device the final merged unified model and the final merged variational autoencoder; and (i) performing backward knowledge distillation to distill knowledge in the final merged unified model to the local complex model of each user device using data generated by the final merged variational autoencoder to obtain an updated local complex model for each user device. In some embodiments, steps (b) to (i) are repeated at least ten times.

### Examples for Fed2KD

As a solution to pandemic risk assessment, a two-way Knowledge Distillation (KD)-based FL framework (Fed2KD) is provided, which enables the training of user-customized models by leveraging a set of unified small models. Two procedures are defined during the training of the framework-forward distillation and backward distillation. During forward distillation, local complex models (i.e., user-configured) distill their knowledge about local data to unified models. After forward distillation, unified models will be uploaded to the server and merged, and then the clients will download the merged models for backward distillation, during which the knowledge about the global data distribution will be distilled into local complex models, such that the local complex models are updated with new global knowledge. However, backward distillation becomes a bottleneck, because only using the local data the global knowledge cannot be distilled out of the unified models, and the local complex (user-configured) models will learn nothing if only the local private data is used. To solve this bottleneck, the conditional variational autoencoder (CVAE) algorithm was adopted to generate meaningful data from the global distribution without leaking any real data. Adding two models to the local clients may seem to be burdensome in terms of memory and computation expenses; however, the sizes of the models are very small compared to the local complex (user-configured) model. Furthermore, CVAEs only need to be trained for several epochs and then can be used for inference.

To evaluate Fed2KD and to prove it outperforms existing FL frameworks, it was first tested on benchmark datasets such as MNIST (Y. LeCun, et al. ATT Labs: http://yann.lecun.com/exdb/mnist, vol. 2, 2010.) and FashionMNIST (H. Xiao, et al. arXiv: 1708.07747 (2017)) against existing frameworks such as FedAvg. Then, it was deployed for the pandemic risk assessment task. A Decentralized Proactive, Predictive, Personalized, Privacy-preserving (4P) COVID-19 recommendation APP was developed. The COVID-19 recommendation APP: (1) is proactive in nature, which helps mitigate the spread of the virus significantly, e.g., it provides recommendations on which path is best to go from place A to B, which regions of the bus/train coach to sit, when to visit which stores in a mall, etc., thereby empowering the user by giving control on what to do, to minimize the risk of contagion while allowing us to continue to live our lives; (2) is endowed with built-in privacy and security features; (3) works both indoors and outdoors; (4) is a robust user-based distributed solution; and (5) achieves high reliability by leveraging collaborative information fusion and model-based verification.

The disclosed Fed2KD has at least the following advantageous characteristics. First, a two-way KD-based federated learning structure was used to train different types and sizes of models. The models can learn from each other without getting access to any local private data. Second, the framework demonstrates high accuracy when evaluated on benchmark datasets such as MNIST and FashionMNIST. Third, the model is able to work with heterogeneous data when evaluated on different levels of Non-IID data to show that. Finally, the model can be used for various applications, such as providing risk prediction for the COVID-19 pandemic when evaluated on a custom-designed phone APP. The results show that the model can work for at least such data type.

### Federated Learning

Federated learning is a framework aiming to optimize a global model by iteratively training and aggregating local models trained on local data. Suppose the FL framework has been set up for a C-class classification problem, and the feature space and label space are defined as [symbol] and [symbol] =[C], respectively. Let [symbol] ={(x₁, y₁), . . . , (x_{M}, y_{M})} represent the dataset where xᵢ∈ [symbol] and yᵢ∈ [symbol] are the features and labels, and M is the size of the dataset. The classifier (e.g., neural network and support vector machine) is denoted as f: [symbol] → [symbol] with

$$𝒮 = \{ 𝓏 \vert {\sum }_{i = 1}^{C} {𝓏}_{i} = 1 , {𝓏}_{i} \geq 0 , ∀ i ∈ 𝒴 \}$$

as the probability space. Vector z £ represents a probability distribution over (classes.

Assuming that Cross Entropy (CE) loss is used, the classification problem can be written as,

$${min}_{θ} {\sum }_{i = 1}^{C} p ( y = i ) {𝔼}_{x \vert y = i} [ log f ( x ; θ ) ] , \qquad ( 1 )$$

where 6 denotes the parameters of the classifier f.

In FL, (1) becomes different with distributed models and unsharable data. Suppose there are K clients participating in the FL training procedure, each client has its own dataset [symbol] ^{k}={(xᵢ^{k}, yᵢ^{k})} with distribution p^{(k)}. If θₜ denotes the merged weights downloaded from the server at time step t and θₜ^{(k)} represents the local weights after local optimization at client k, the weight update for a local model is.

$${θ}_{t}^{( k )} = {θ}_{t - 1}^{( k )} - η {\sum }_{i = 1}^{c} {p}^{( k )} ( y = i ) {∇}_{θ} {𝔼}_{x \vert y = i} [ log f ( x ; {θ}_{t - 1}^{( k )} ) ] , \qquad ( 2 )$$

where η is the factor for controlling the step size (a.k.a. learning rate). After the local update, the weights of the model are uploaded to the server for merging. Let M^{(k)} denote the size of the dataset on client k, the merge can be written as.

$${θ}_{t + 1} = {\sum }_{k = 1}^{K} \frac{{M}^{( k )}}{{\sum }_{k = 1}^{K} {M}^{( k )}} {θ}_{t + 1}^{( k )} , \qquad ( 3 )$$

which can be considered as an average of the local parameters weighted by the fraction of data the client has w.r.t. the entire dataset.

### Knowledge Distillation

Knowledge Distillation (KD) is also known as the teacher-student framework, which aims at learning a lightweight student model by distilling the knowledge from the teacher. KD frameworks usually involve a proxy dataset, [symbol] ^{p}, on which the teacher and the student are trained for knowledge extraction. The outputs of the teacher and student are collected to calculate the distance as the objective to be optimized. Kullback-Leibler divergence (KL divergence) is a popular metric to measure the distance of the distributions given by the teacher and student. Let θ^{(T)} and θ^{(S)} denote the parameters for the teacher model and student model, respectively. The objective of KD can be written as,

$$l ( {θ}^{( S )} ) = {D}_{KL} [ σ ( f ( x ; {θ}^{( T )} ) ) ‖ σ ( f ( x ; {θ}^{( S )} ) ) ] , \qquad ( 4 )$$

$$= {𝔼}_{x , y ∼ {𝒟}^{p}} [ log \frac{σ ( f ( x ; {θ}^{( T )} ) )}{σ ( f ( x ; {θ}^{( S )} ) )} ] \qquad ( 5 )$$

where σ(·) is the non-linear activation function and D_{KL} is the KL divergence. By backpropagating the KL divergence loss between the outputs from two models, the student model can learn how much difference between its output and the output from the teacher model, and thus it can learn to behave like the teacher.

### Two-Way Knowledge Distillation for Federated Learning

Heterogeneous user models were considered, which indicates that the traditional train-and-average method for merging models in FedAvg is not working in this setting. To formally define the disclosed framework, the notation was adopted from the previous sections. With distributed models and data, FL is updated by extracting the local knowledge from local models and merging them to get the global knowledge. However, (3) does not work for heterogeneous models because different sizes of parameters (i.e., matrices) cannot be summed and averaged.

This problem was solved by introducing knowledge distillation to the FL framework. The intuition is that the knowledge is distilled out of the local models, merged to get the average, and then sent back to the clients. Nonetheless, the existing KD frameworks are mostly one-to-one and many-to-one, and applying these frameworks will introduce significant computation and communication overhead. For example, if the pairwise KD method is adopted, the distillation procedure has to be run (N/2) times.

The solution to this problem is to leverage a set of small models parameterized by π^{(k)} with the unified configurations deployed on the clients which will help the heterogeneous models to converge to the consensus. The complex models (i.e., the original local heterogeneous models) and the unified models will form teacher-student relationships in turn in the KD paradigm. The complex model will first be trained on the local dataset, and then transfer the (local) knowledge to the unified model. The unified model will then be uploaded to the server for aggregation following (3). After merging, the unified models are supposed to contain global knowledge and will be downloaded to the clients. Then, the small models will distill their knowledge to the complex models so that the big ones are updated with new knowledge from others, that is, the complex model and the small model form a knowledge transfer circle. Adopting (4), the distillation from complex models to unified models can be written as.

$${min}_{{π}^{( k )}} {𝔼}_{x , y ∼ {𝒟}^{p}} [ {D}_{KL} [ σ ( f ( x ; {θ}^{( k )} ) ) ‖ σ ( f ( x ; {π}^{( k )} ) ) ] ] . \qquad ( 6 )$$

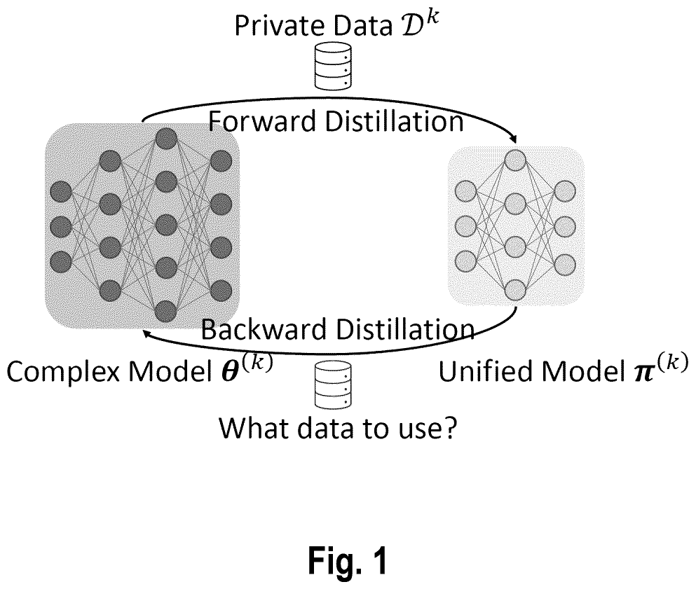

However, there is a problem with this setting. The forward distillation (i.e., distilling knowledge from complex models to small models) can be easily achieved by training the models on the local dataset with cross-entropy loss and KL divergence loss, and yet the backward distillation seems to be impossible because only local data can be used which will not trigger the small models' knowledge about the others. FIG. 1 provides a more illustrative example. As is shown, the knowledge can be distilled out of the complex model using the local data because the knowledge it has is local, but the knowledge cannot be distilled from unified models because the knowledge is global and the data that is available is local. Thus, in order to solve this problem, a new way to distill the knowledge out of the small models must be developed. The most straightforward way is to share data across clients, and the results show that by sharing a small fraction of data, the performance of models can be greatly improved.

However, this violates the bottom line of FL, which is no data sharing. Therefore, a data generation method that is reliable and does not require data sharing is sought. The idea of the method is to generate a dataset of infinite size with every possible value combination in the feature spaces so that the complex model can learn to mimic the small model in every possible way until they contain the same knowledge. However, this is quite absurd due to memory and time constraints. One more realistic way is to generate meaningful noise from the distribution of the dataset. To that end, Conditional Variational Autoencoder (CVAE) was employed.

### Conditional Variational Autoencoder

A popular method for generating data is a variational autoencoder (VAE). VAE consists of an encoder, which maps the original data to the latent space, and a decoder, which maps the data in the latent space back to the original form. Besides the encoder-decoder pair, VAE also introduces a latent variable into the framework. Formally speaking, the autoencoder assumes that the original data x is conditioned on a latent variablez. Based on the scheme described, VAE regards the latent variable as a random variable, and the encoding and decoding processes become probabilistic processes. With that being said, the encoder and decoder can be represented as p(z|x) and p(x|z), respectively. Assuming that p(x|z) is Gaussian with a mean defined by a function of latent variable z and a covariance matrix with form cI, where c is a constant and I is the identity matrix, the decoder can be further written as p(x(z)= [symbol] (f(z), cI). As for the encoder, VAE tries to approximate it using a Gaussian distribution qₓ(z) with a mean defined by g(x) and variance defined by h(x). The encoder can now be represented as p(z|x)=qₓ(z)= [symbol] (g(x), h(x)). With the definitions above, the encoding process becomes generating the mean and variance for a Gaussian distribution, and the decoding becomes sampling z from the distribution and decoding it. Moreover, to enable the gradients to be propagated through the sampling process, an important technique, the reparameterization trick, is introduced. The sampling process now becomes the addition of random noise and a deterministic process through which the gradients can be passed. With the trick, the sampling of random variable z can be written as,

$$z = h ( x ) ζ + g ( x ) , \qquad ( 7 )$$

where ζ˜ [symbol] (0, I) is random Gaussian noise. With a trained VAE, random noise can be fed to the decoder, and it will output data that approximate the original dataset. As demonstrated, a variation of the VAE, namely Conditional VAE, was used, which conditions on the label information so that the generator can generate data according to labels instead of just random noise.

To improve smoothness and continuity in the latent space, VAE-based method introduced a regularization term in the loss function besides the reconstruction error. The regularization term encourages the generated Gaussian distribution, i.e., the outputs of the encoder, to approach the standard Gaussian distribution. However, this regularization term only constrains the distance between the generated Gaussian and the standard Gaussian without considering the spreading of the points in the latent space. Take two as the latent space dimension as an example. The regularization term drives the generated means of the Gaussian distributions to be close to the origin point. However, there is a possibility that all of the points lie in a small region in the 2D space close to the origin point. In this case, during the generation process, if the random noise sampled from the standard Gaussian lies in a distant area from the small region, the decoder will have problems reconstructing the origin data from the noise.

To this end, a cosine similarity regularization term was used in the loss function of CVAE to encourage the generated means in the latent space to spread more uniformly. A list of class means, which records the average of the means for each class, was maintained. Denote μ_{c} as the class mean for the class c. The loss function for it can be written as,

$$L ( {η}^{( k )} ) = {L}_{recon} ( {η}^{( k )} ) + β {D}_{KL} [ 𝒩 ( {g}_{{η}^{( k )}} ( x ) , {h}_{{η}^{( k )}} ( x ) ) ‖ 𝒩 ( 0 , I ) ] - γ {\sum }_{j \neq c} \frac{{g}_{{η}^{( k )}} ( x ) \cdot {μ}_{j}}{‖ {g}_{{η}^{( k )}} ( x ) ‖ ‖ {μ}_{j} ‖} ,$$

Where β and γ are weights for the regularization terms.

With the help of CVAE, the backward distillation can be formulated as,

$${min}_{{θ}^{( k )}} {𝔼}_{\hat{x} ∼ G ( \cdot ; \hat{y} , {η}^{( k )} ) , \hat{y} ∼ p ( y )} [ {D}_{KL} [ σ ( f ( \hat{x} ; {π}^{( k )} ) ) ‖ σ ( f ( \hat{x} ; {θ}^{( k )} ) ) ] ] , \qquad ( 8 )$$

Where G(·; ŷ, η^{(k)}) denotes the CVAE on the ith client parameterized by η^{(k)} and \hat{x} and ŷ are data generated by CVAE, respectively.

```
Algorithm 1 Fecl2KD Algorithm
User configures θ₀⁽¹⁾, ... , θ₀^{(K)}
Initialize Uni Model π₀
Initialize CVAE Model η₀
for round t = 1,2, ... do
  for each client k ∈ K in parallel do
    πₜ₊₁^{(k)}, ηₜ₊₁^{(k)} ← ForwardDistill(θₜ^{(k)}, (ηₜ^{(k)}
  $\begin{matrix}{π}_{t + 1} ← {\sum }_{k = 1}^{K} \frac{{M}^{( k )}}{{\sum }_{k} {M}^{( k )}} {π}_{t}^{( k )} \\ {η}_{t + 1} ← {\sum }_{k = 1}^{K} \frac{{M}^{( k )}}{{\sum }_{k} {M}^{( k )}} {η}_{t}^{( k )}\end{matrix}$
  for each client k ∈ K in parallel do
    θₜ₊₁^{(k)} ← BackwardDistill(πₜ₊₁^{(k)}, ηₜ₊₁^{(k)})
procedure ForwardDistill(θₜ^{(k)}, (ηₜ^{(k)})
  θₜ₊₁^{(k)} ← Update θₜ^{(k)} according to Eq. (2)
  πₜ₊₁^{(k)} ← Update πₜ^{(k)} according to Eq. (6)
  ηₜ₊₁^{(k)} ← Update ηₜ^{(k)} on local data D^{k}
Return πₜ₊₁^{(k)}, ηₜ₊₁^{(k)}
procedure BackwardDistill(πₜ₊₁^{(k)}, ηₜ₊₁^{(k)})
  Generate ŷ~p(y)
  Generate \hat{x}~G(.; ŷ,ηₜ₊₁^{(k)})
  θₜ₊₁^{(k)} ← Update θₜ^{(k)} according to Eq. (8)
  Return θₜ₊₁^{(k)}
```

Now that every part of the framework is available, but one has to consider a question: why not use CVAEs trained in a federated manner to help the complex models? The results presented herein show the disclosed method has a better performance than directly using CVAEs.

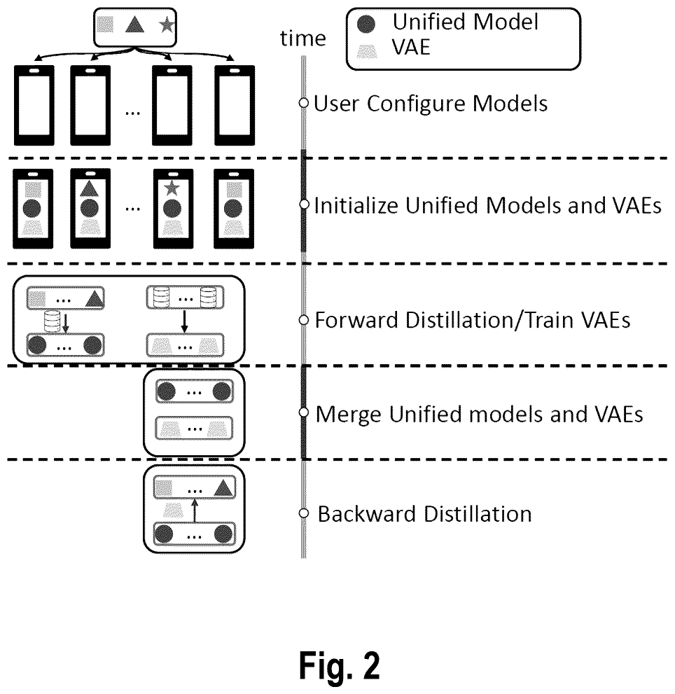

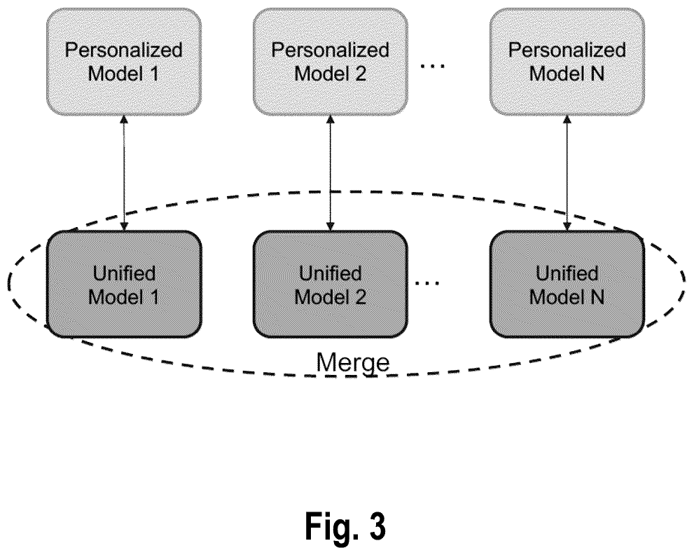

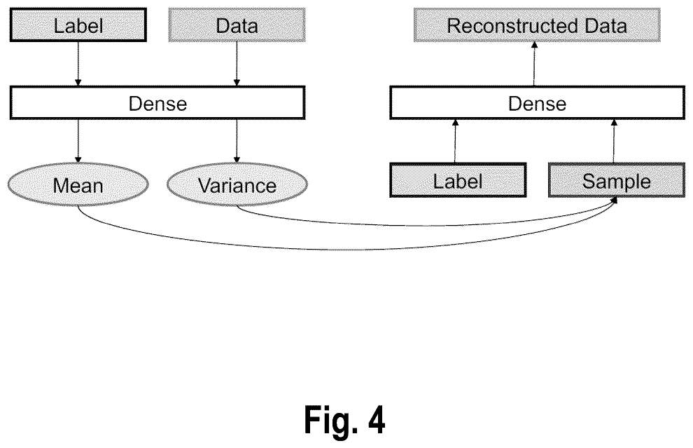

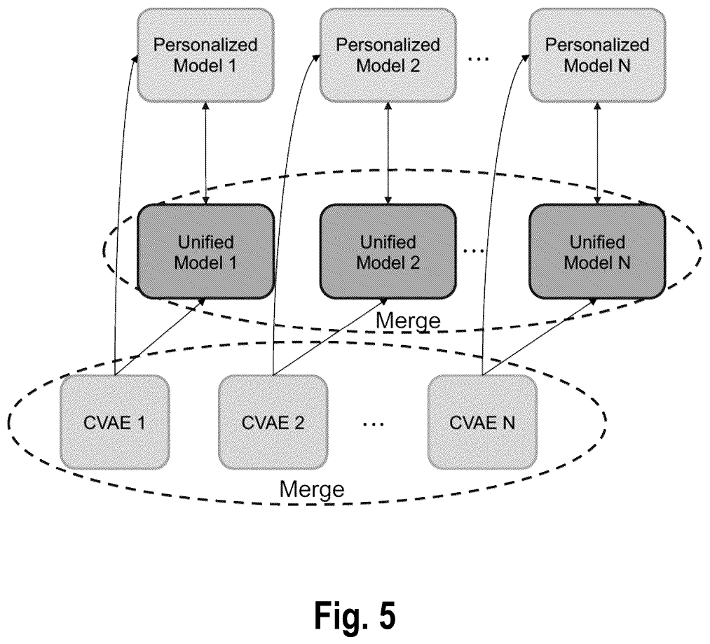

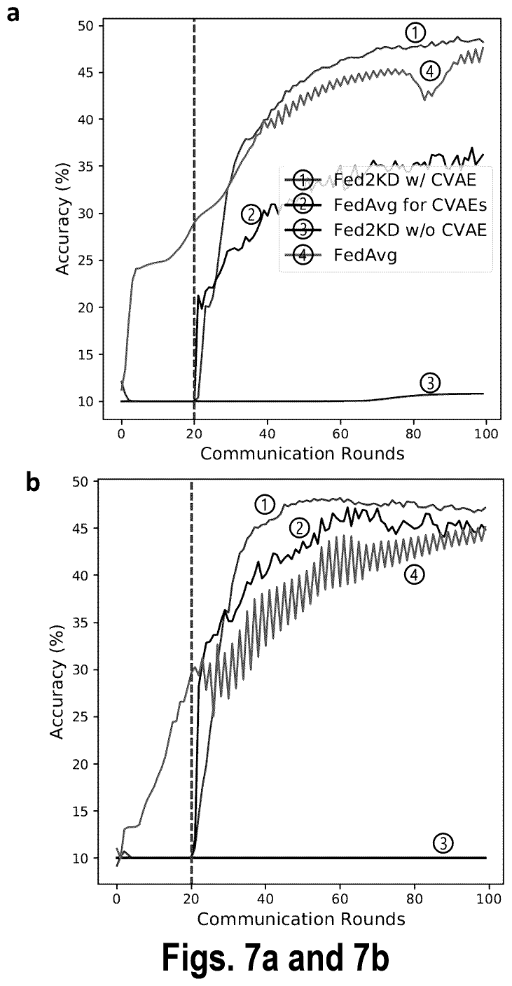

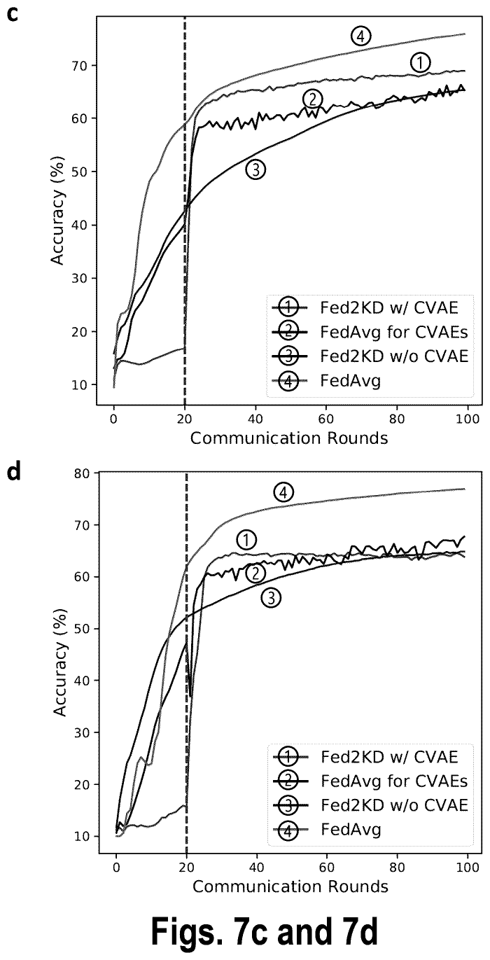

The whole workflow of Fed2KD is shown in FIGS. 2-8, and the detailed diagram can be found in Algorithm 1. The framework is initiated by a user to configure the client models and initialize the unified models and CVAEs. Then, the complex models and CVAEs are trained using local data. The trained complex models will distill their knowledge to the unified small models which will be uploaded and merged after the forward distillation. After model aggregation on the server's side, the clients will download the unified models and CVAEs and perform the backward distillation using the data generated by CVAE. The framework keeps iterating between forward and backward distillation until one or more stop criteria are met. For example, an example of stop criteria is a deviation between the prediction by a current model and that by a model from the previous iteration. The deviation can be less than 10% (e.g., less than 10%, 9%, 8%, 7%, 6%, 5%, 4%, 3%, 2%, 1%, 0.5%, 01%, etc.)

### Evaluation

To evaluate the disclosed algorithm, it was first tested on the benchmark datasets to show that the performance of the model is accurate by comparing it with existing methods. Then, the algorithm was evaluated on a real risk prediction task through a custom developed APP, named DP4coRUna. The algorithm framework is embedded in the APP, and a AWS server was used to form a centralized learning architecture.

### Benchmark Dataset Evaluation

Experiment Setup: 10 clients were used for the experiments, and each of them has a configurable complex model, a small model, and a VAE model. The complex models can be MLP or CNN, and the sizes can be anything that the device can afford. Five Multilayer Perceptions (MLPs) of size and five CNNs with three convolution modules were used, where each module contains a convolution layer and a max-pooling layer in the experiment. A small MLP of size [256] was used as the unified model in the experiment. The VAE model is also realized in a MLP form of size as an encoder and as a decoder. All models use learning rate=0.01 with Adam optimizer (D. P. Kingma and J. Ba, arXiv: 1412.6980v9 [cs.LG] 30 Jan. 2017). The framework and the experiment are implemented in Python using the PyTorch framework (A. Paszke, et al., Curran Associates, Inc., 2019, pp. 8024-8035). The local update epoch was set as 1, which means that only one epoch of local update was performed on the private data, and then the forward and backward distillation was conducted. Each client possesses 500 samples of data, and the batch size is 64.

The disclosed Fed2KD with three other models were compared—
i. Fed2KD without CVAE, in which only complex models and unified models are deployed on each client using only the local data for both forward and backward distillation,
   ii. FedAvg for CVAE, in which only complex models and CVAE are used, and the whole framework becomes how to train a good generator using FedAvg on CVAE models, and
      iii. FedAvg, which is used as a baseline. However, FedAvg only works for a model with the same configuration, and, to compare it with other heterogeneous frameworks, two FedAvg frameworks for each dataset were trained, where one uses 10 MLPs of size [128, 256, 256] and the other uses 10 CNNs with three convolution modules.

Dataset: To test how well the model performs, it was run on two benchmark datasets, MNIST and FashionMNIST. MN1ST is a dataset for handwritten digits recognition tasks, and it consists of 70,000 images of digits from 0 to 9 of size 28×28, which are divided into 10,000 testing sets and 60,000 training sets. Similar to MNIST, the FashionMNIST dataset is a dataset of Zalando's article images, including pictures of shoes, trousers, and so on, and it also contains 60,000 examples for a training set and a test set of 10,000 examples.

Data Heterogeneity: Data are drawn from a Dirichlet distribution Dir(a) with parameter a α∈(0, ∞) to control the data heterogeneity. The greater α, the less concentrated the data is (e.g., more distributed over the clients), i.e., with α→∞, the data will be identically distributed over the clients, and as α→0, each client will only possess the data from one class. For the experiments, four values for a were chosen.

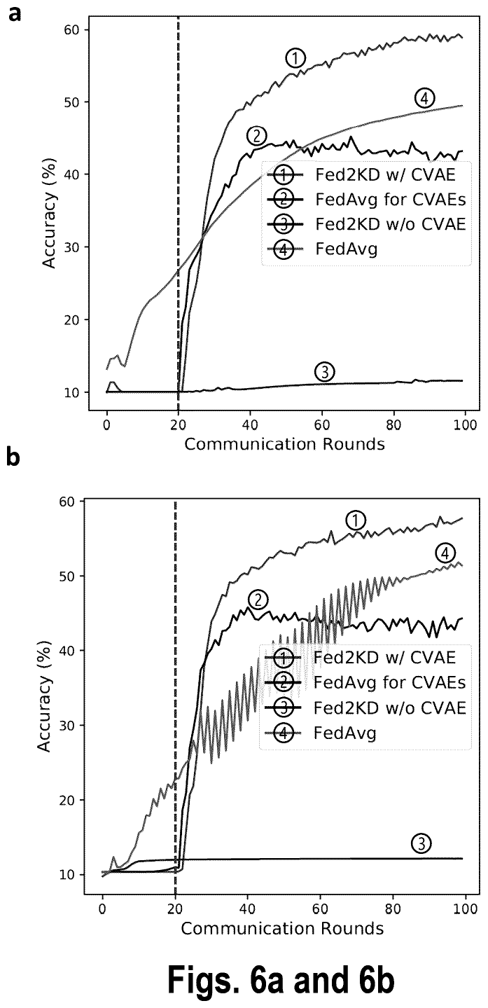

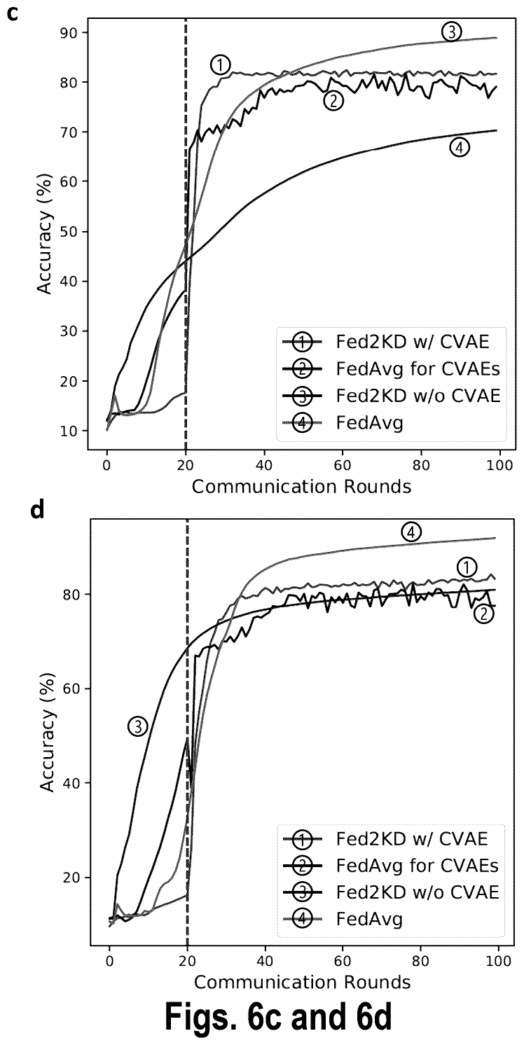

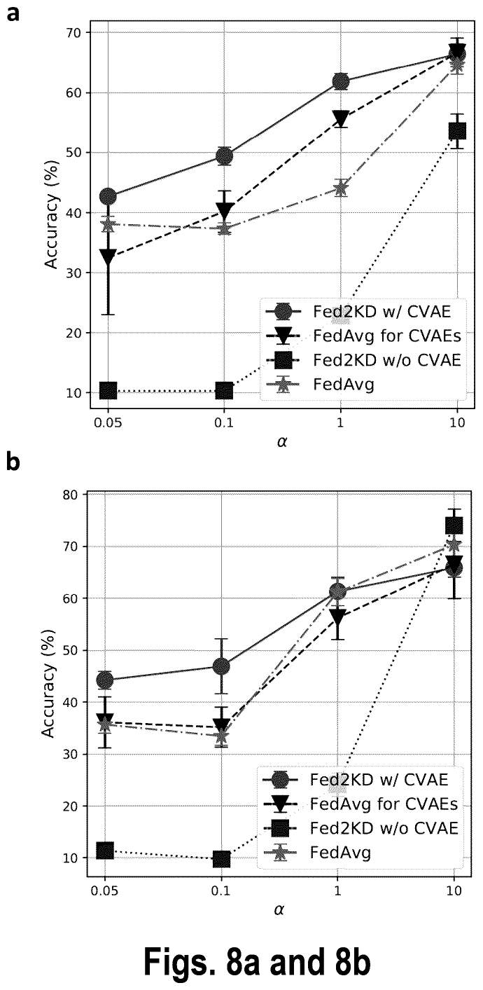

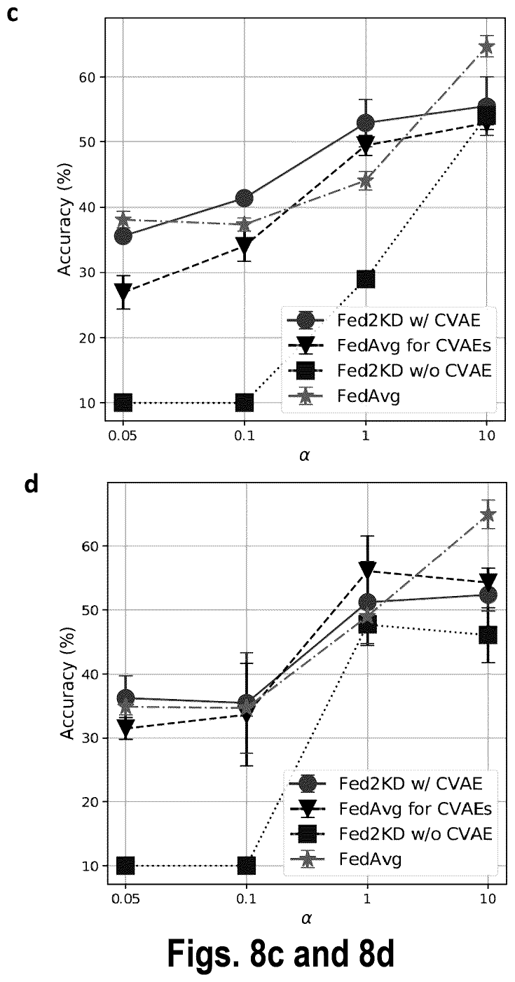

Results: FIGS. 6-8 present the results of the experiments on MNIST and FashionMNIST datasets, respectively. Additional results are provided in Tables I and II. There are several notable facts from the results:
1. When α is high, all four frameworks work well. The reason for this outcome is that the difference in client data distribution is not very significant, and the model can learn good global knowledge even on its local data. As α decreases, the performance of the framework without CVAE drops significantly. This is because the distances between client data distributions are getting larger, and simply training on local data cannot learn any global knowledge.
2. When α approaches 0.05, the disclosed Fed2KD outperforms FedAvg for CVAEs. This is because the CVAE models do not converge to a stable state, and they cannot provide trustworthy samples to the complex models for backward distillation.
3. The dashed line at x=20 indicates that CVAE is started to be involved in the training process. It is obvious that with the help of CVAE, both Fed2KD and Fed2KD without unified models are improved significantly. Thus, with data generated by CVAE, the bottleneck of backward distillation is eased. As shown in FIG. 8, for both datasets, when a increases, the model performance improves. Fed2KD w/o CVAE is the most improved model, which is because the backward distillation is completely blocked when α is small; as the data are distributed more evenly, it gets access to more data in other classes and, thus, the performance increases. Furthermore, FedAvg achieves better performance when α has a greater value, which is within expectation because FedAvg can handle IID-distributed data well.

### Mobile Risk Assessment

The evaluation of Fed2KD on benchmark datasets shows that it is a good and reliable framework for federated learning.

TABLE I
Test accuracy for models trained on MNIST dataset.
Test Accuracy on MNIST (%)

| Model | α | MLP | CNN |
|---|---|---|---|
| Fed2KD | 0.05 | 58.90 ± 1.84 | 57.68 ± 0.36 |
| FedAvg for CVAE | | 43.17 ± 5.93 | 44.27 ± 5.44 |
| Fed2KD w/o CVAE | | 11.54 ± 0.03 | 12.14 ± 0.06 |
| FedAvg | | 37.91 ± 1.28 | 35.65 ± 1.65 |
| Fed2KD | 0.1 | 65.72 ± 2.14 | 66.59 ± 2.11 |
| FedAvg for CVAE | | 52.90 ± 9.30 | 51.06 ± 9.56 |
| Fed2KD w/o CVAE | | 13.79 ± 0.03 | 15.83 ± 0.02 |
| FedAvg | | 35.21 ± 1.29 | 33.45 ± 1.78 |
| Fed2KD | 1 | 67.70 ± 0.49 | 59.78 ± 5.75 |
| FedAvg for CVAE | | 60.68 ± 1.72 | 63.24 ± 5.90 |
| Fed2KD w/o CVAE | | 34.51 ± 1.73 | 37.40 ± 0.21 |
| FedAvg | | 60.75 ± 1.99 | 61.20 ± 2.61 |
| Fed2KD | 10 | 65.99 ± 2.67 | 63.87 ± 0.98 |
| FedAvg for CVAE | | 65.40 ± 0.67 | 64.87 ± 0.13 |
| Fed2KD w/o CVAE | | 69.39 ± 2.95 | 70.30 ± 3.46 |
| FedAvg | | 64.65 ± 1.62 | 64.95 ± 2.19 |

TABLE II
Test accuracy for models trained on FashionMNIST dataset.
Test Accuracy on FashionMNIST (%)

| Model | α | MLP | CNN |
|---|---|---|---|
| Fed2KD | 0.05 | 48.27 ± 4.14 | 45.00 ± 0.75 |
| FedAvg for CVAE | | 36.20 ± 3.21 | 38.52 ± 2.97 |
| Fed2KD w/o CVAE | | 10.80 ± 0.02 | 12.00 ± 0.03 |
| FedAvg | | 37.74 ± 1.24 | 34.86 ± 1.23 |
| Fed2KD | 0.1 | 55.71 ± 1.29 | 47.15 ± 11.13 |
| FedAvg for CVAE | | 44.39 ± 2.89 | 44.84 ± 5.36 |
| Fed2KD w/o CVAE | | 15.30 ± 0.05 | 9.99 ± 0. |
| FedAvg | | 37.34 ± 0.97 | 34.66 ± 1.22 |
| Fed2KD | 1 | 67.70 ± 0.49 | 59.78 ± 5.75 |
| FedAvg for CVAE | | 60.68 ± 1.72 | 63.24 ± 5.90 |
| Fed2KD w/o CVAE | | 34.51 ± 1.73 | 37.40 ± 0.21 |
| FedAvg | | 44.06 ± 1.42 | 48.99 ± 1.58 |
| Fed2KD | 10 | 68.99 ± 2.67 | 63.87 ± 0.98 |
| FedAvg for CVAE | | 65.36 ± 1.22 | 67.76 ± 4.05 |
| Fed2KD w/o CVAE | | 65.40 ± 0.67 | 64.87 ± 0.13 |
| FedAvg | | 64.65 ± 1.62 | 64.95 ± 2.19 |

Therefore, in this section, a custom-developed mobile APP is introduced, which utilizes Fed2KD for pandemic risk assessment. The APP has three core modules:
i. Localize=Mark: provides accurate indoor user localization and k-anonymity-based infection marking. Localize+Mark first obtains the route information (source and destination) directly from the user. It then calculates and marks the infectious risk associated with each of these candidate paths/activities using the indoor/outdoor location information of users associated with such paths/activities using the k-anonymity mechanism that preserves user privacy. The indoor/outdoor localization functionality only needs Wi-Fi Access Points (AP) as input (i.e., features), and it can provide accurate predictions for users' locations. Data collected from different locations are tagged with different labels with the associated features (e.g., Wi-Fi APs and signal strengths). In this way, a distributed database is built, and, to query a user's location, only the database needs to be searched for a match of the features.
ii. ContTrace: determines people who have been there recently, where the database entries of two devices are compared to find a similarity match. ContTrace identifies the people who had been in contact with a particular person or location (say ‘specimen’) in the past two weeks, which is accomplished as follows. The database records (i.e., the locations and their sensor signatures) of specimens corresponding to the last two weeks are queried over the ToR network to identify devices whose databases have matching information in the last two weeks. When a device receives these query records, it initiates a comparison check to see if any of the query records are similar to the records in its database. If it is so, then the APP alerts the user that s/he had been in potential contact with an infected person in the past two weeks and suggests the user self-quarantine and contact the health provider. When this happens, the APP also presents the matching records (with sensor signatures including Wi-Fi, Cell ID, etc.) in its database that are similar to the query for user validation. This software module can be replaced with other solutions, e.g., Apple/Google APP if needed, while still reaping the benefits of the other modules.
iii. Recommend: The last module takes the outputs of the previous modules to generate the top 25 recommendations for the user in decreasing order of strength. The user can then choose the option that best fits his/her requirements. In this way, the APP provides users with valuable information and puts them in a position to make the best decision for themselves.

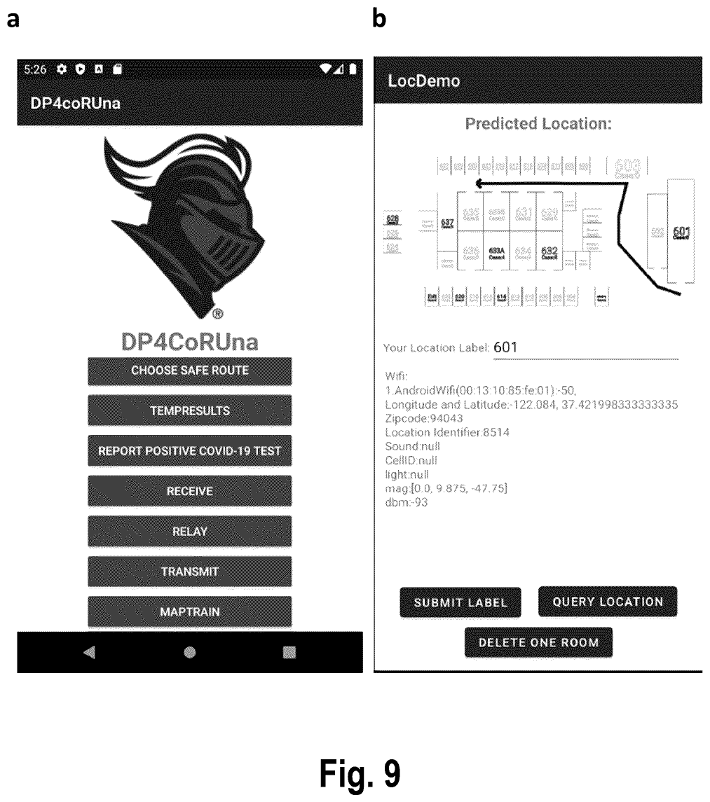

Demo of Fed2KD with DP4coRUna: To illustrate how to apply Fed2KD on the COVID-19 scenario, the data flow of the APP is illustrated. After downloading the APP, the user needs to first report whether he/she is positive. FIG. 9(a) shows the User Interfaces (UIs) for the front page and the entrance to report positive. After reporting, the APP will train the Fed2KD model on the mobile devices of users who reported positive. The training goes on for several iterations, and a global risk map will be generated from the training process. With this map, the top k safest can be found, which will be provided for users to choose from.

An indoor example is showcased, assuming that there are n users and each of them has been to one of the n rooms with no replacement, which means that each device has the data of one unique, dangerous zone. With the help of Localizes Mark and ContTrace modules, the clients' devices are able to know where the users have been and thus generate data and labels correspondingly. For example, if user A that is tested positive has been to room A, then data {(LocationOf RoomA, 1)} will be generated where 1 stands for positive and 0 represents negative. With multiple users, a federated learning structure is formed, and after following the training procedure, when another user queries the server for a risk over the whole area, he/she will get results as predicted. The risk scores in the locations of the high-risk zones are significantly higher than in other areas, and the margins have been softened to consider the spread of viruses. With the risk scores, the APP can calculate top k safest routes, where A: is a predefined number, from a starting location to a destination with the Recommend module. FIG. 9(b) shows an example routing demonstration using the 6th floor of the Rutgers CoRE building. The risky rooms are marked as red, and the user is trying to travel from room 601 to room 635. The recommended route in blue color directs the user to avoid the dangerous rooms.

As disclosed, Fed2KD, a two-way knowledge distillation-based federated learning framework, can jointly train heterogeneous models of different types and sizes. The forward and backward distillations during its training were defined, and the backward distillation bottleneck was identified. To solve this bottleneck, the Conditional Variational Autoencoder (CVAE) was used to generate the proxy dataset for backward distillation, where the unified models distill their global knowledge to the complex models. To evaluate the disclosed model, it was first tested on two benchmark datasets (MNIST and FashionMNIST) and compared with FedAvg for CVAE and Fed2KD without CVAE. The results showed that the performance of the disclosed model is better than that of the other two methods. Then, the model was evaluated on the COVID-19 risk assessment mobile APP. It was assumed that multiple rooms in a building had been infected by test-positive individuals, and risk scores for the whole floor map were generated. The region around the rooms showed a significantly higher score than other areas.

### Communication-efficient Federated Learning Design with Fronthaul Awareness in NG-RANS

In yet another aspect, this disclosure also provides a method for efficient federated learning. In some embodiments, the method comprises: (i) configuring a local complex model of each user device; (ii) training the local complex model of each user device using local data in each user device; (iii) transmitting to at least one intermediate layer comprising one or more edge server devices trained local complex models of at least a subset of a plurality of user devices; (iv) merging the trained local complex models of at least a subset of the plurality of user devices at each of the one or more edge server devices; (v) transmitting to a central unit layer comprising a server device the merged local complex models from the one or more edge server devices; (vi) further merging at the central unit layer the merged local complex models from the one or more edge server devices to obtain a final merged complex model; (vii) transmitting from the central unit layer, through the at least one intermediate layer, to each user device the final merged complex model; and (viii) updating the local complex model of each user device based on the final merged complex model to obtain an updated local complex model for each user device.

In some embodiments, step (i) comprises initializing a local unified model and a local variational autoencoder (VAE) of each user device.

In some embodiments, step (ii) comprises training the local variational autoencoder (VAE) of each user device using local data in each user device.

In some embodiments, the method comprises, after step (ii) and prior to step (iii), performing forward knowledge distillation to distill knowledge in the trained local complex model to the local unified model of each user device.

In some embodiments, step (iii) comprises transmitting to the one or more edge server devices of the at least one intermediate layer local unified models and trained local variational autoencoders from a least a subset of the plurality of user devices after completion of the forward knowledge distillation.

In some embodiments, step (iv) comprises merging the local unified models and the local variational autoencoders at the one or more edge server devices of the at least one intermediate layer.

In some embodiments, step (v) comprises transmitting to the central unit layer the merged unified models and the merged local variational autoencoders from the one or more edge server devices.

In some embodiments, step (vi) comprises further merging, at the central unit layer, the merged unified models and the merged local variational autoencoders from the one or more edge server devices to obtain a final merged unified model and a final merged variational autoencoder.

In some embodiments, step (vii) comprises transmitting from the central unit layer, through the at least one intermediate layer, to each user device the final merged unified model and the final merged variational autoencoder.

In some embodiments, step (vii) comprises updating the local complex model of each user device based on the final merged unified model and data generated by the final merged variational autoencoder.

In some embodiments, the step of merging the local unified models comprises averaging the local unified models. In some embodiments, the step of merging the local variational autoencoders comprises averaging the local variational autoencoders.

In some embodiments, the local variational autoencoder (VAE) is a conditional variational autoencoder (CVAE).

In some embodiments, a local complex model of a user device is different from a second local complex model of another user device. In some embodiments, the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks.

### Examples for FedNG

To overcome the challenges of the privacy demand and the limited capacity of the fronthaul links in NG-RAN, FL for privacy-preserving and latency-aware services were leveraged in the NG-RAN systems. The disclosed FedNC algorithm enables DUs to cooperatively learn a shared predictive model by assuming the first-phase training models of the DUs as the initial input of the local training and then uploading sub-optimal local models to the CUs to involve in the next phase of global training.

The privacy and traffic management problems were addressed in two scenarios: (i) distributed FL solution, NG-FedAvg algorithm, in which a learning model can be trained cooperatively between the computing servers (DUs) and the end-users (UEs) to achieve the required accuracy level; and (ii) disclosed FedNG algorithm, in which a two-layer-aggregation federated learning paradigm is to improve the overall system performance. Hence, a learning model can be trained cooperatively between the CU, DUs, and UEs, to achieve the required accuracy level.

To efficiently evaluate the disclosed framework, extensive experiments were performed using three real-world datasets—MNIST with Dense Neural Networks (DNNs, Cl-FAR 10 with convolutional neural networks (CNNs), and IMDB sentimental analysis dataset with recurrent neural networks (RNNs). In the three datasets, the performance of the disclosed framework shows a significant improvement compared with existing traditional Federated Averaging (FedAvg) in terms of accuracy, service latency, and traffic size.

### Overall NO-KAN System Design

This section first presents the network description, including NG-RAN architecture and network layers. Followed by the learning model, which presents the main terms and equations of the FL framework, as well as a distributed solution for the NC-FedAvg algorithm.

### A. Network Description

For demonstration, it was assumed that a generic NG-RAN architecture comprises three layers (see FIG. 10) listed as follows,

Central unit layer: contains powerful processing servers, providing on-demand computation/radio functions for uplink/downlink wireless communication channels between the UEs and gNBs. In terms of FL, the local model generated by mobile user devices can be collected as a global model and sent back to the UEs for extra training.

Distributed unit layer: consists of a set of edge servers deployed in proximity to end-users to provide radio/computation services. In the context of FL, DU servers can be exploited to perform local data processing functions, in which each DU server is used as a local aggregator to exchange the model between end-users and CU servers.

UE layer: comprises a set of UEs, [symbol] ={1,2, . . . , U}, randomly distributed in the network cell. Each UE is equipped with an antenna/sensor to collect data, which is used for training purposes, from the NG-RAN environment. Due to the UE location in the vicinity of the DUs, each UE has the ability to exchange the training model to its DUs for local aggregations to experiment with high QoS and low latency. Accordingly, it was assumed that each DU interacts with a set [symbol] ={1,2, . . . , S} of S servers. Also, it was assumed that DU s associates with a set [symbol] ={1,2, . . . , Uₛ} of Uₛ UEs with U= [symbol] Uₛ, and each UE is served by one DU server.

### B. Learning Model

A NG-RAN system, as depicted in FIG. 10, was considered in which each mobile user u, ∀u ∈ [symbol] , in this system is connected to DU s, ∀s∈ [symbol] via a wireless channel to collect a local input dataset [symbol] ᵤₛ={x_{d}, y_{d}}_{d=1}^{|D}^{ᵤₛ}| where x_{d}∈ [symbol] ^{f} and y_{d}∈ [symbol] are a f-dimensional input vector and the corresponding label, respectively. Assuming non-i.i.d. distributed data through the wireless network, [symbol] ᵤₛ∩D_{úś}=∅, ∀(u, s)≠(ú, ś).

Definition 1. The terms “local model” and “local aggregation model” are referred to as the models generated by UEs and DUs, respectively, while averaging at CU is referred to as the “global model.”The key goal of the FL system is to leverage the datasets of all UEs without sacrificing their privacy. In light of this, a loss function is denoted as l(w, x_{d}, y_{d}) for each data sample (x_{d}, y_{d}) to specify the estimated error between the input x on the learning model w∈ [symbol] ^{f} and the corresponding label y_{d}. The local loss function of the learning model w on the dataset Dᵤₛ can be defined as,

$${L}_{us} ( w \vert {𝒟}_{us} ) = \frac{1}{{𝒟}_{us}} {\sum }_{d ∈ {𝒟}_{us}} l ( w , {x}_{d} , {y}_{d} ) . \qquad ( 1 )$$

Due to the randomness of the UE data distributions, it was assumed that the empirical loss function through the overall network dataset D=∪_{u,s} Dᵤₛ can be modeled as:

$$L ( w \vert {𝒟}_{us} ) = \frac{{\sum }_{u ∈ {𝒰}_{s}} {\sum }_{s ∈ 𝒮} {L}_{us} ( w \vert {𝒟}_{us} )}{U} . \qquad ( 2 )$$

In general, the target of designing a FL algorithm is to achieve the optimal model w* minimizing the global loss value as,

$${w}^{*} = arg {min}_{w ∈ {ℝ}^{f}} {L}_{us} ( w \vert {𝒟}_{us} ) . \qquad ( 3 )$$

It was aimed at developing an algorithm for the end users in the NG-RAN system to efficiently achieve the solution of the optimization problem in (3).

### C. Distributed Solution

To achieve the optimal solution in (3), Federated Averaging (FedAvg) algorithm, which is a standard algorithm in the FL, was extended using a distributed approach to iterative minimize the local loss in (3). The main steps of the disclosed NG-FedAvg algorithm for the NG-RAN system can be listed as follows,
i. Data Collecting: For the first time, each UE sends its collected data from a third-party application. Then, the learning models can be constructed based on the empirical risk minimization criterion with respect to the loss function, in which the Deterministic Gradient Descent (DGD) method algorithms are usually utilized to adjust the local parameters.
ii. Global model broadcasting: At the beginning of the global round, CU sends the latest version of the global model to all associated UEs in set Uₛ.
iii. Local training update: In this phase, each UE u that associates with DU s updates the local parameters as,

$${w}_{us}^{( i ) , j + 1} = {w}_{us}^{( i ) , j + 1} - {ξ}^{( i )} ∇ {L}_{us} ( {w}_{us}^{( i ) , j} \vert {𝒟}_{us} ) , ∀ i ∈ 𝒥 , j ∈ 𝒥 , \qquad ( 4 )$$

Where the learning set size, ξ⁽ⁱ⁾>0, is often decreased over time; and J={0,1, . . . , J−1} and I={0,1, . . . , I−1} are the sets of I global rounds and J local iterations, respectively.
iv. Local uploading: When the local model, wᵤₛ^{(i),j} of UE (u, s) is accomplished, it will be sent back to the DU s server via the wireless cellular channels. Practically, the model parameters are sent into the baseband signals via different processes (e.g., modulation, coding, and compression) to preserve transmission reliability. Then, DU s forward the local training model, wᵤₛ^{(i),j} , to CU for averaging.
v. Global uploading: After uploading all local tanning models to the CU, CU conducts global training updates as,

$${w}^{( i ) + 1} = \frac{{\sum }_{u ∈ {𝒰}_{s}} {\sum }_{s ∈ 𝒮} {w}_{us}^{( i ) , j}}{U} . \qquad ( 5 )$$

The steps (i)-(v) in the NG-FedAvg algorithm are repeated until convergence. Although the NG-FedAvg algorithm can distributive\hat{ } find the solution for (3), forwarding the local models from DUs to CU can incur the fronthaul link extra traffic load, which is prohibitive in a large-scale NG-RAN. To tackle this issue, a FedNG algorithm was developed for local aggregations in the next section. The NC-FedAvg algorithm is detailed in Algorithm 1.

Algorithm 1 NG-FedAvg Algorithm

| | |
|---|---|
| 1: | Initialize local model weights |
| 2: | Initialize CU Aggregation frequency F |
| 3: | repeat |
| 4: | The CU broadcast w⁽ⁱ⁾ thought DUs to all users |
| 5: | Each UE (u, s) computes the local training update according to (4) |
| 6: | UEs upload their updated learning model to the associated DUs |
| 7: | Each DU forwards the received learning model to CU |
| 8: | CU determines the global learning model according to (5) |
| 9: | until Convergence |

### III. FedNG Algorithm Design

In this section, a FL algorithm, named FedNG, is disclosed to achieve the optimal value of w in (3), followed by the proof of FedNG convergence.

### A. The FedNG Algorithm

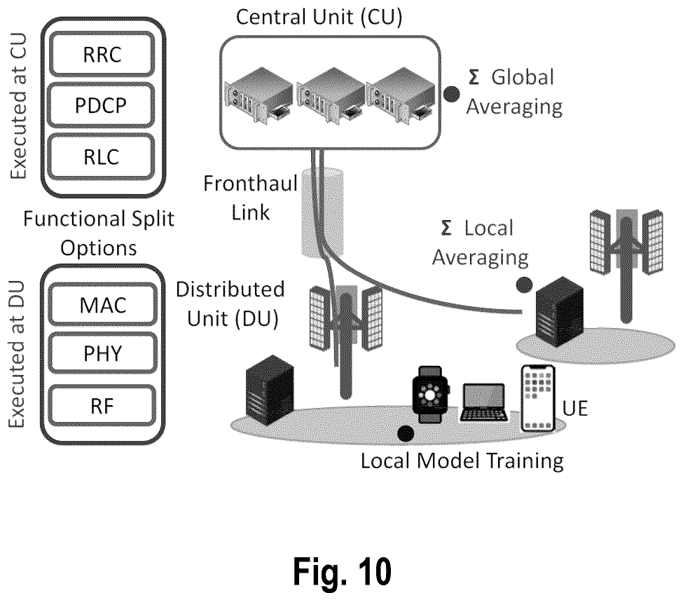

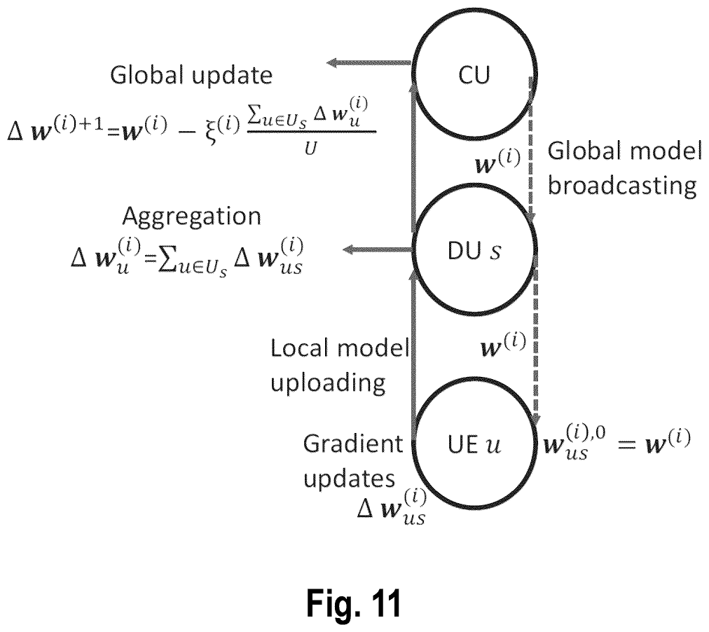

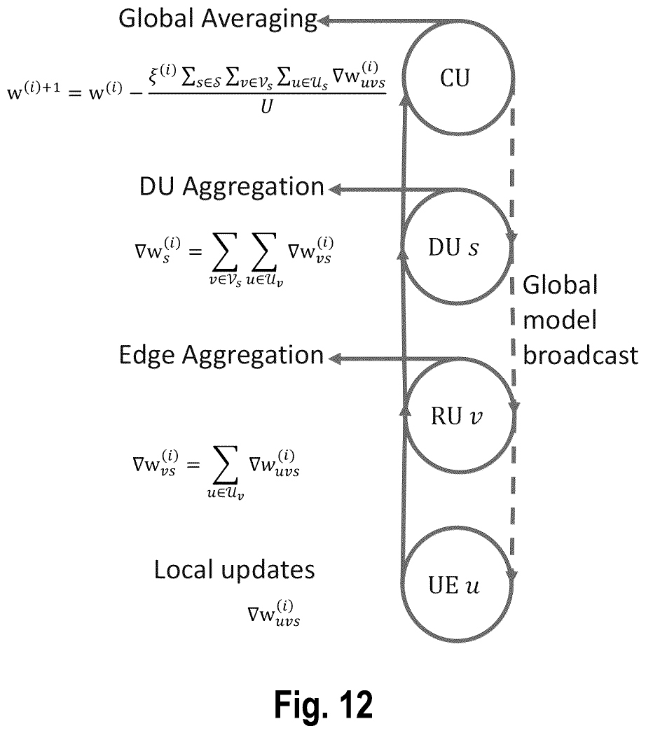

One of the major challenges in performing the NC-FedAvg algorithm at the NG-RAN system is the capacity-limited fronthaul constraint. Hence, in FIG. 11, the training processes of the disclosed FedNG algorithm are described. In the beginning, at round i, the end-user (u, s) determines/gradient updates on the collected data. In the DU layer, each DU aggregates the collected local gradient models from the associated UEs and forwards these models to CU for global updating. In the CU layer, CU computes from the latest global model, w⁽ⁱ⁾, the updated global model, w⁽ⁱ⁾⁺¹, which is later returned to the end-users through the DUs to start a new round. Specifically, the key steps of the FedNG algorithm are presented as follows,
(i) Local model update: As mentioned, in the NG-FedAvg algorithm, each UE determines its training model by utilizing the DGD method, in which the fronthaul capacity consumed is considered in a large-scale NG-RAN scenario. Therefore, in the FedNG algorithm, instead of performing the local training process for each UE in (4), the Stochastic Gradient Descent (SGD) method is utilized to determine the gradient on mini-batches. Accordingly, it was assumed that Aul\hat{ } is the mini-bach with size A=| [symbol] ᵤₛ^{(i),j}| which is randomly sampled from end-user (u, s) at round (i) of the local iteration j. Hence, UE (u, s) can update the local parameters as,

$${w}_{us}^{( i ) , j + 1} = {w}_{us}^{( i )} - {ξ}^{( i )} ∇ {L}_{us} ( {w}_{us}^{( i ) , j} , {x}_{d} , {y}_{d} ) , j = 0 , 1 , … , J - 1 , \qquad ( 6 )$$

where the stochastic gradient can be calculated as,

$$∇ {L}_{us} ( {w}_{us}^{( i ) , j} \vert {𝒜}_{us}^{( i ) , j} ) = \frac{{\sum }_{d ∈ {𝒜}_{us}^{( i ) , j}} ∇ l ( {w}_{us}^{( i ) , j} , {x}_{d} , {y}_{d} )}{A} . \qquad ( 7 )$$

Hence, the constraint, [symbol] {∇Lᵤₛ(wᵤₛ^{(i),j}| [symbol] ᵤₛ^{(i),j})}=∇Lᵤₛ(wᵤₛ^{(i),j}|Dᵤₛ) should be established to estimate the gradient in (7) properly. Practically, since the only size of [symbol] ᵤₛ^{(i),j} is fixed during the training rounds, the total stochastic updates for each end user can be written as,

$$∇ {w}_{u s}^{( i ) , j} = {\sum }_{j ∈ 𝒥} ∇ {L}_{u s} ( {w}_{u s}^{( i ) , j} \vert {𝒜}_{u s}^{( i ) , j} ) , \qquad ( 8 )$$

where (8) leads to satisfying the condition, wᵤₛ^{(i),j}−wᵤₛ^{(i),0}=−ξ⁽ⁱ⁾∇wᵤₛ⁽ⁱ⁾.

(ii) Local model aggregation: In this step, DU s repeatedly aggregate gradient parameters as,

$$∇ {w}_{u s}^{( i )} = {\sum }_{u ∈ {𝒰}_{s}} {\sum }_{j ∈ 𝒥} ∇ {L}_{u s} ( {w}_{u s}^{( i ) , j} \vert {𝒜}_{u s}^{( i ) , j} ) = {\sum }_{u ∈ {𝒰}_{s}} ∇ {w}_{u s}^{( i )} \qquad ( 9 )$$

(ii) Global model update: After all the DUs forward the aggregated gradient parameters to CU for global update, which can be determined as,

$${w}^{( i ) + 1} = {w}^{( i )} - \frac{{ξ}^{( i )} {Σ}_{u ∈ {𝒰}_{s}} {Σ}_{s ∈ 𝒮} ∇ {w}_{u s}^{( i )}}{U} = {w}^{( i )} - \frac{{ξ}^{( i )} {Σ}_{s ∈ 𝒮}}{U} . \qquad ( 10 )$$

After the aggregated gradient parameters are determined, they will be forwarded back to the end user to begin a new global round. Algorithm 2 shows the details of the disclosed FedNC algorithm. It can be observed that the FedNG algorithm does not require end users to send their raw data to DUs and CU. Hence, the FedNC algorithm can secure more privacy for UEs while reducing the overhead fronthaul traffic in NC-RAN.

B. FedNG Convergence

The convergence of the FedNG algorithm is discussed and proven in Theorem 1 as.

Algorithm 2 FedNG Algorithm

| | |
|---|---|
| 1: | Input: I, J, U, S, [symbol] ᵤₛ, ∀u ∈ [symbol] , s ∈ [symbol] |
| 2: | Initialize local model weights |
| 3: | Initialize the global model, w⁽⁰⁾, at CU with learning rate ξ⁽⁰⁾ |
| 4: | for i ∈ [symbol] do |
| 5: | w⁽ⁱ⁾ sent from CU to all DUs |
| 6: | for u ∈ [symbol] ₛ in parallel do |
| 7: | for s ∈ [symbol] in parallel do |
| 8: | DU s sends wᵤₛ^{(i),j} to each UEs |
| 9: | for j ∈ [symbol] do |
| 10: | Each UE samples a new minbach [symbol] ᵤₛ^{(i),j} with size A and |
| | calculates ∇Lᵤₛ (wᵤₛ^{(i),j}\| [symbol] ᵤₛ^{(i),j}) as in (7) |
| 11: | end for |
| 12: | Each UE us calculate ∇wᵤₛ^{(i),j} as in (8) and uploads it to the |
| | associated DU |
| 13: | end for |
| 14: | Each DU s aggregates all the received gradient parameters as in |
| | (9) |
| 15: | end for |
| 16: | CU calculates global update as in (10) |
| 17: | end for |
| 18: | Output: w^{(I)} |

Theorem 1. Given w*,

$$𝔼 \{ {‖ {w}^{0} - {w}^{*} ‖}^{2} \} , Υ = max \{ \frac{64 Λ}{κ} , 4 G \}$$

and learning step size

$${ξ}^{( i )} = \frac{16}{κ ( ( i ) + 1 + Υ )} ,$$

the upper bound of the FedNG can be achieved afterI global bound as,

$$E \{ {‖ {w}^{( I )} - {w}^{*} ‖}^{2} \} \leq \frac{max \{ {Υ}^{2} 𝔼 \{ {‖ {w}^{0} - {w}^{*} ‖}^{2} \} , {( \frac{16}{κ} )}^{2} IQ \}}{{( I + Υ )}^{2}} , where \qquad ( 11 )$$

$$Q = 2 {( G μ )}^{2} + ( 2 + \frac{κ}{4 Λ} ) ( I - 1 ) L {μ}^{2} + \frac{I {\sum }_{u ∈ {𝒰}_{s}} {Σ}_{s ∈ 𝒮} {κ}_{u s}^{2}}{{U}^{2}} + \frac{6 Λ I}{U} {\sum }_{u ∈ {𝒰}_{s}} {\sum }_{s ∈ 𝒮} {ϵ}_{u s} .$$

Proof. In order to prove Theorem 1 (i.e., the convergence of the disclosed algorithm), several assumptions were made while doing the analysis.

Assumption 1. Let Lᵤₛ(W): [symbol] ^{f}→ [symbol] is Λ-smooth and κ-strongly convex function, i.e.,

$${L}_{u s} ( w ) \geq {L}_{u s} ( \hat{w} ) + ∇ {L}_{u s} ( w ) ( w - \hat{w} ) + \frac{κ}{2} ‖ w - \hat{w} ‖ ,$$

∀w, ŵ∈ [symbol] ^{f}. Also, Lᵤₛ(ŵ) is an Λ-Lipschitz continuous gradient, i.e., ∥∇Lᵤₛ(w)−∥∇Lᵤₛ(ŵ)≤Λ∥w−ŵ∥, ∀w, ŵ∈ [symbol] ^{f}Λ≥0.

Assumption 2. (Bounding the variance.) At UE (u, s), let [symbol] {∇Lᵤₛ(wᵤₛ^{(i),j}| [symbol] ᵤₛ^{(i),j})−∇Lᵤₛ(wᵤₛ^{(i),j}| [symbol] ᵤₛ)}≤αᵤₛ², ∀u∈ [symbol] ₛ, s∈ [symbol] , i∈ [symbol] , j∈ [symbol] , is an upper bound on the variance αᵤₛ² and [symbol] {∥∇Lᵤₛ(wᵤₛ⁽ⁱ⁾| [symbol] ᵤₛ^{(i),j})∥²}≤μ², ∀u∈ [symbol] ₛ, s∈ [symbol] , i∈ [symbol] , j∈ [symbol] is an upper bound on the variance μ².

By holding Assumption 1,

$$𝔼 \{ {‖ {\sum }_{u ∈ {𝒰}_{s}} {\sum }_{s ∈ 𝒮} \frac{1}{U} ( ∇ {L}_{u s} ( {w}_{us}^{( i ) , j} ) - ∇ {\hat{L}}_{u s} ( {w}_{us}^{( i ) , j} ) ) ‖}^{2} \} \leq \frac{{\sum }_{u ∈ {𝒰}_{s}} {\sum }_{s ∈ 𝒮} {α}_{u s}^{2}}{{U}^{2}} . \qquad ( 12 )$$

By holding Assumption 2,

$$\frac{1}{U} 𝔼 \{ {‖ {\hat{w}}^{( i ) , j} - {w}_{us}^{( i ) , j} ‖}^{2} \} \leq ( J - 1 ) {J ( {ξ}^{( i )} )}^{2} {μ}^{2} . \qquad ( 13 )$$

By holding Assumptions 1 and 2, the expected upper bound of w* when ξ⁽ⁱ⁾≤1/4Λ, can be written as.

$$𝔼 \{ {‖ {\hat{w}}^{( i ) , l + 1} - {w}^{*} ‖}^{2} \} \leq ( 1 - \frac{1}{2} {κξ}^{( i )} ) 𝔼 \{ {‖ {\hat{w}}^{( i ) , l + 1} - {w}^{*} ‖}^{2} \} + {( {ξ}^{( i )} )}^{2} {Φ}^{( i ) , j} + \frac{2 {ξ}^{( i )}}{U} {\sum }_{u ∈ {𝒰}_{s}} {\sum }_{s ∈ 𝒮} 𝔼 \{ {\hat{L}}_{u s} ( {w}^{*} ) - {\hat{L}}_{u s} ( {\hat{w}}^{( i ) , j} ) \} \qquad ( 14 )$$

where

$${Φ}^{( i ) , j} = 2 + ( \frac{κ}{Λ} ) ( J - 1 ) {μ}^{2} + \frac{1}{{U}^{2}} {\sum }_{u ∈ {𝒰}_{s}} {\sum }_{s ∈ 𝒮} {α}_{u s}^{2} + \frac{6 Λ}{U} {\sum }_{u ∈ {𝒰}_{s}} {\sum }_{s ∈ 𝒮} {τ}_{us} ; {τ}_{u s} = {L}_{u s} ( w \vert {D}_{u s} ) - {L}_{u s}^{*}$$

is the data heterogeneity factor between one user and the other; and L*ᵤₛ is the minimum local loss function. Hence, the convergence of the FedNG can be calculated in (11). The proof is complete.

### C. FedBNG

In an NG-RAN, edge servers can be deployed in conjunction with radio units (RUs) to perform a variety of functions, such as caching frequently accessed content, processing data, and providing low-latency access to applications and services. By combining an edge server with an RU, it is possible to offload some processing and data management tasks from the CU node to the edge of the network. This can help reduce the burden on the fronthaul interface and improve the efficiency and performance of the network.

Furthermore, the deployment of an edge server with an RU can enable the implementation of edge-computing applications and services that require low latency and high bandwidth, such as Augmented Reality (AR) and Virtual Reality (VR), industrial automation, and autonomous vehicles. In other words, by bringing compute and storage resources closer to the user, edge servers with RUs can help improve the quality of experience for end-users. This can be especially beneficial for applications that require real-time processing and low-latency communication, which may not be feasible with a centralized cloud architecture. Edge servers with RUs can be used in NG-RAN to support FL by allowing the training of machine-learning models to be performed at the edge of the network, closer to the data sources, instead of at a centralized cloud server.

Denote each edge as v∈ [symbol] with [symbol] being the set of all edges. For each DU s, its connected edges are represented by [symbol] ={1,2, . . . , Vₛ}. With edges, some notations from the introduced above are slightly modified as following. Since the UEs are now connected directly with the edges instead of the DUs, we use [symbol] ={1,2, . . . , Uᵥ} to denote the UEs connected to edge v. Let wᵤᵥₛ^{(i),j} represent the local parameters of UE u, where v represents its connected edge and s the DU it connects to through edge v. Following this revised notation, the local mini-batch is denoted as [symbol] .

After local training, each edge will collect the parameters from its connected UEs and aggregate them before uploading to the DU. The edge-level aggregation can then be written as,

$$∇ {w}_{v s}^{( i )} = {\sum }_{u ∈ {𝒰}_{𝓋}} {\sum }_{j ∈ 𝒥} ∇ {L}_{u v s} ( ∖ v {w}_{u v s}^{( i ) , j} \vert {𝒜}_{𝓊𝓋𝓈}^{( 𝒾 ) , 𝒿} ) = {\sum }_{u ∈ {𝒰}_{𝓋}} ∇ {w}_{u v s}^{( i )} .$$

After edge-level aggregation, the edges will upload their parameters ∇wᵥₛ⁽ⁱ⁾ to the DUs for aggregation, which can be written as,

$$∇ {w}_{s}^{( i )} = {\sum }_{v ∈ {𝒱}_{𝓈}} {\sum }_{u ∈ {𝒰}_{𝓋}} {\sum }_{j ∈ 𝒥} ∇ {L}_{u v s} ( {w}_{u v s}^{( 𝒾 ) , 𝒿} \vert {A}_{𝓊𝓋𝓈}^{( 𝒾 ) , 𝒿} ) = {\sum }_{v ∈ {𝒱}_{𝓈}} ∇ {w}_{v s}^{( i )} .$$

Finally, the DUs will upload the aggregated parameters to the CU for the last aggregation, which can be written as,

$${w}^{( i ) + 1} = {w}^{( i )} - \frac{{ξ}^{( i ) {\sum }_{s ∈ 𝒮} {\sum }_{v ∈ {v}_{𝓈}} {\sum }_{u ∈ {𝒰}_{𝓋}} ∇ {w}_{u v s}^{( i )}}}{U} .$$

FedBNG introduces an edge-level aggregation to reduce the user-perceived latency because the edge is closer to the UEs than the DUs, with acceptable sacrifice in the accuracy because the number of connected UEs in the edge level is less than it is in the DU level.

### IV. Performance Evaluation

In this section, the disclosed FL-based scheme was evaluated on three datasets with three different types of models-MNIST with Dense Neural Networks (DNNs), CI-FAR10 with convolutional neural networks (CNNs), and IMDB sentimental analysis dataset with recurrent neural networks (RNNs). Different UE-DU association methods were compared, including nearest, in which each UE connects to the closest DU, and best-SINR, in which each UE selects the one with the best SINR from the visible DUs. These two methods were also compared with the baseline model FedAvg.

Simulation Settings: For NC-RAN simulation, randomly scattered UEs with uniformly located DUs were considered. Taking fading channels into account, it was assumed that large-scale fading is the same for all sub-bands and small-scale fading is frequency-selective and flat. Define gⱼᵤ as the channel gain from DU j to UE u and it is determined as, gᵤₛ=dᵤₛ^{ls}|hᵤₛ|², ∀u∈ [symbol] , s∈ [symbol] , where dᵤₛ^{ls} is the large-scale fading, including pass loss and shadowing, and hᵤₛ is the small-scale Rayleigh fading. To model the Rayleigh fading, the small-scale fading is modeled as a first-order complex Gauss-Markov process, and the update rule is,

$${h}_{u s} = ρ {h}_{u s} + \sqrt{1 - {ρ}^{2}} {e}_{us} ,$$

∀∈ [symbol] , s∈ [symbol] , where ρ=J₀(2πf_{d}T) is the correlation between two adjacent fading blocks, J₀ is the zero-order Bessel function of the first kind and is the maximum Doppler frequency. Tis the time separation re-estimated as the channel gain. eᵤₛ is the channel innovation process and they follow circularly symmetric complex Gaussian distribution. A greater value of p means that the channel has changed significantly since the last channel estimation, which could be caused by large Tor a rapidly changing f_{d}. Further, three types of models-DNN, CNN, and RNN were used. The DNN is realized with two layers with [128, 128] units for the layers. The CNN is implemented with three convolutional modules, which consist of a 2D convolutional layer, a 2D max-pooling layer and an activation function, with kernel size 3 and stride 1. The RNN model is realized with a two-layer Long Short Term Memory (LSTM) unit with one fully connected layer as the last layer for the output. The learning rate is 0.01 for all models, and the batch sizes are 32, 4, and 128 for three datasets, respectively. The framework is implemented with Python 3.6 and Pytorch, a deep learning toolkit.

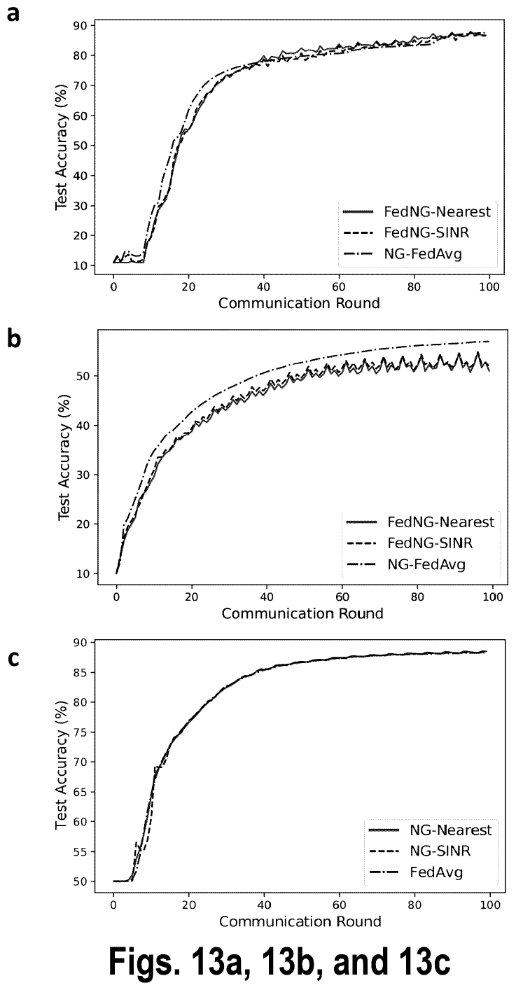

Comparison of Accuracy: To show how the disclosed model work in terms of accuracy, the accuracy change during training was plotted in FIG. 13. In all three datasets, three models achieve similar performances. Particularly, in FIG. 13(b) FedAvg slightly outperforms the other two models, but this advantage is acceptable. As will be further discussed below, the disclosed framework can achieve a much lower latency without reducing a significant level of accuracy.

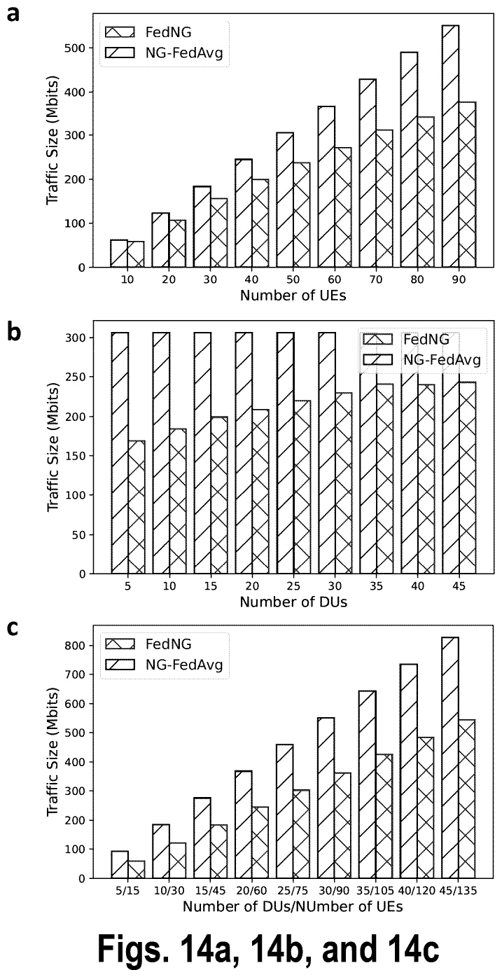

Comparison of Traffic: To compare the traffic between CU and DUs needed to update the disclosed FL frameworks with other frameworks, the results are presented in FIG. 14. The number of UEs involved in the training process was varied in FIG. 14(a), and it is clear that as the number UEs increase, the traffic size increases as well. Additionally, in FedAvg framework, more traffic is transmitted than it in NG-FedAvg, and the difference is growing larger as the number of UEs increases. In FIG. 14(b), the number of DUs was varied to see how the traffic size changes. For FedAvg, every UE needs to connect to the CU for aggregation, and therefore, the traffic size does not change. For NG-FedAvg, however, the traffic size grows slowly as the number of DU increases, which is because the DU distribution becomes denser and UEs are connecting to more different DUs. Finally, in FIG. 14(c), the ratio of the number of DUs was maintained over the number of UEs unchanged, and their absolute values were varied to see how the traffic sizes would be affected. As shown, the number of UEs seems to dominate the results as the difference between the two frameworks grows as the number of UEs and DUs vary.

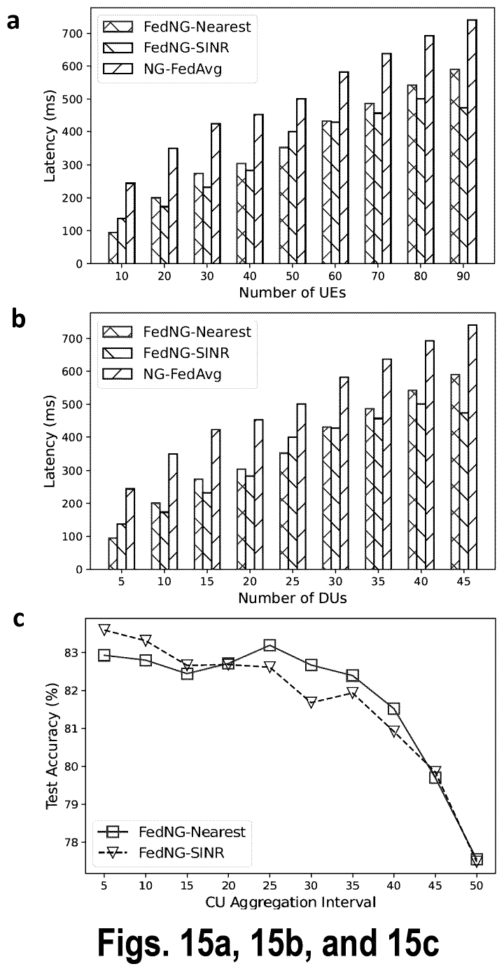

Comparison of Latency: In FIGS. 15(a) and 15(b), the latency perceived by the UEs for all three frameworks is shown. FedAvg has a much larger latency than the other two frameworks. This is because, for each communication round in FedAvg, the UE needs to communicate with the centralized CU while, in the disclosed framework, UEs only need to exchange information with the DUs which are closer to them physically, and thus the latency is reduced.

Impact of CU Aggregation Interval: In the disclosed framework, the centralized CU aggregates the models on DUs with a predefined interval. To show how this interval affects the accuracy of the federated learning framework, a corresponding plot is shown in FIG. 15(c). As the aggregation interval increases, the accuracy of the two models does not change much at the beginning and then drops dramatically. A threshold was initially at around 45, after which the performance of the models dropped significantly. Furthermore, different UE-DU association connections can get quite different results. This figure is generated using the MNIST dataset with 30 UEs.

As demonstrated, the Next Generation Radio Access Networks (NG-RANs) can be a promising architecture to satisfy the high on-demand requirements for 5G and beyond applications. To address the main challenge in NG-RAN, the limited fronthaul capacity and privacy, a Federated Learning (FL)-based NG-RAN algorithm, named FedNG, is disclosed, in which the User Equipment (UEs), as well as NG-RAN infrastructures, help each other throughout the learning and the training process to relieve the burden on fronthaul interface and secure the privacy for end-users. Finally, numerical simulations were carried out using three real-world datasets, MNIST, Fashion-MNIST, and IMDB. The performance of the disclosed algorithm showed a significant improvement compared with existing traditional Federated Averaging (FedAvg) in terms of accuracy, service latency, and traffic size.

### Additional Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

The terms “memory,” “memory device,” “computer-readable storage medium,” “data store,” “data storage facility,” and the like each refer to a non-transitory device on which computer-readable data, programming instructions or both are stored. Except where specifically stated otherwise, the terms “memory,” “memory device,” “computer-readable storage medium,” “data store,” “data storage facility,” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

In addition, the terms “unit,” “-er,” “-or,” and “module” described in the specification mean units for processing at least one function and operation, and can be implemented by hardware components or software components and combinations thereof.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

Aspects of the present disclosure are described herein with reference to flowchart illustrations and/or block diagrams of methods, apparatus (systems), and computer program products according to embodiments of the invention. In some embodiments, the flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically stated otherwise, it is appreciated that throughout the disclosure, descriptions utilizing terms such as “obtaining,” “performing,” “receiving,” “computing,” “associating,” “assigning,” “traversing,” “calculating,” “determining,” “identifying,” “transforming,” “ranking,” “providing,” “transmitting,” or the like, refer to the action and processes of a computer system, or similar electronic computing device, that manipulates and transforms data represented as physical (or electronic) quantities within the computer system memories or registers or other such information storage, transmission or display devices.

As used herein, the term “logistic regression” is a regression model for binary data from statistics where the logit of the probability that the dependent variable is equal to one is modeled as a linear function of the dependent variables.

As used herein, the term “neural network” is a machine learning model for classification or regression consisting of multiple layers of linear transformations followed by element-wise nonlinearities typically trained via stochastic gradient descent and back-propagation.

The term “machine learning,” as used herein, refers to a computer algorithm used to extract useful information from a database by building probabilistic models in an automated way.

The term “regression tree,” as used herein, refers to a decision tree that predicts values of continuous variables.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

It is noted here that, as used in this specification and the appended claims, the singular forms “a,” “an,” and “the” include plural reference unless the context clearly dictates otherwise. The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure, unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for heterogeneous federated learning through two-way knowledge distillation, comprising:
(a) configuring a local complex model of each user device and initializing a local unified model and a local variational autoencoder (VAE) of each user device;
(b) training the local complex model and the local variational autoencoder of each user device using local data in each user device;
(c) performing forward knowledge distillation to distill knowledge in the trained local complex model to the local unified model of each user device;
(d) transmitting to a server device local unified models and trained local variational autoencoders from a plurality of user devices after completion of the forward knowledge distillation;
(e) merging the local unified models and the local variational autoencoders at the server device;
(f) transmitting from the server device to each user device a merged unified model and a merged variational autoencoder; and
(g) performing backward knowledge distillation to distill knowledge in the merged unified model to the local complex model of each user device using data generated by the merged variational autoencoder to obtain an updated local complex model for each user device.

2. The method of claim 1, wherein steps (b) to (g) are repeated at least ten times.

3. The method of claim 1, wherein steps (b) to (g) are repeated until a difference between prediction from the local complex model and prediction from the updated local complex model is less than 2%.

4. The method of claim 1, wherein the local variational autoencoder (VAE) comprises a conditional variational autoencoder (CVAE).

5. The method of claim 4, wherein the conditional variational autoencoder (CVAE) uses a cosine similarity regularization term in a loss function.

6. The method of claim 1, wherein the step of merging the local unified models comprises averaging the local unified models.

7. The method of claim 1, wherein the step of merging the local variational autoencoders comprises averaging the local variational autoencoders.

8. The method of claim 1, wherein a local complex model of a user device is different from a second local complex model of another user device.

9. The method of claim 1, wherein the local complex model comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks.

10. The method of claim 1, wherein the local complex model comprises one or more machine learning models.

11. The method of claim 1, wherein the local complex model comprises a neural network, a convolutional neural network (CNN), a deep convolutional neural network (DCNN), a cascaded deep convolutional neural network, a simplified CNN, a shallow CNN, or a combination thereof.

12. The method of claim 1, wherein the local data of a user device is not shared with another user device or the server device.

13. The method of claim 1, wherein the local unified model, the local variational autoencoder, the merged unified model, or the merged variational autoencoder does not contain personally identifiable information.

14. The method of claim 1, wherein the local data of each user device comprises location data of a user.

15. The method of claim 1, wherein the local data comprises exposure status of a user to a contagious disease.

16. The method of claim 15, wherein the contagious disease is COVID-19, influenza, or respiratory syncytial virus.

17. The method of claim 1, wherein the step of transmitting from the server device to each user device is performed through one or more intermediate layers.

18. The method of claim 17, wherein the one or more intermediate layers comprise at least one distributed unit layer and/or at least one edge user layer.

19. The method of claim 18, wherein the at least one distributed unit layer or the at least one edge user layer comprises one or more edge server devices deployed in proximity to the plurality of user devices.

20. The method of claim 19, wherein the one or more intermediate layers comprise an edge aggregation layer between the at least one distributed unit layer and the at least one edge user layer, and wherein the edge aggregation layer performs functions comprising caching frequently accessed content, processing data, and/or providing low-latency access to applications and services.

21. The method of claim 20, comprising: before steps (d),
transmitting to the one or more intermediate layers the local unified models and the trained local variational autoencoders from the plurality of user devices after completion of the forward knowledge distillation, wherein each of the one or more edge server devices of the one or more intermediate layers receives the local unified models and the trained local variational autoencoders of at least a subset of the plurality of user devices;
merging the local unified models and the local variational autoencoders of at least the subset of the plurality of user devices at the one or more edge server devices; and
transmitting from the one or more edge server devices to the server device merged unified models and merged variational autoencoders to perform further merging at step (e).

22. The method of claim 21, wherein step (f) comprises transmitting from the server device, through the one or more intermediate layers, to each user device a final merged unified model and a final merged variational autoencoder.

23. A method for efficient implementation of a method of heterogeneous federated learning through two-way knowledge distillation according to claim 1, comprising:
(a) configuring a local complex model of each user device and initializing a local unified model and a local variational autoencoder (VAE) of each user device;
(b) training the local complex model and the local variational autoencoder of each user device using local data in each user device;
(c) performing forward knowledge distillation to distill knowledge in the trained local complex model to the local unified model of each user device;
(d) transmitting to one or more intermediate layers comprising one or more edge server devices local unified models and trained local variational autoencoders from the plurality of user devices after completion of the forward knowledge distillation, wherein each of the one or more edge server devices receives the local unified models and the trained local variational autoencoders of at least a subset of the plurality of user devices;
(e) merging the local unified models and the local variational autoencoders of at least the subset of the plurality of user devices at the one or more edge server devices;
(f) transmitting from the one or more edge server devices to a central unit layer comprising a server device merged unified models and merged variational autoencoders to perform further merging;
(g) further merging the merged local unified models and the merged local variational autoencoders at the server device to obtain a final merged unified model and a final merged local variational autoencoder;
(h) transmitting from the server device through the one or more intermediate layers to each user device the final merged unified model and the final merged variational autoencoder, and
(i) performing backward knowledge distillation to distill knowledge in the final merged unified model to the local complex model of each user device using data generated by the final merged variational autoencoder to obtain an updated local complex model for each user device.

24. The method of claim 23, wherein steps (b) to (i) are repeated at least ten times.
